(19) United States
(12) Patent Application Publication
(10) Pub. No.: US 2026/0370349 A1
(43) Pub. Date: Nov. 19, 2026

(54) SYSTEM AND METHOD FOR LONG-DISTANCE QUANTUM-CAPABLE INTERNET

(71) Applicant: THE RESEARCH FOUNDATION FOR THE STATE UNIVERSITY OF NEW YORK, Albany, NY (US)

(72) Inventors: Eden FIGUEROA, Setauket, NY (US); Dimitrios KATRAMATOS, Wading River, NY (US); Guodong CUI, Port Jefferson, NY (US); Leonardo CASTILLO VENEROS, Stony Brook, NY (US); Dounan DU, Stony Brook, NY (US)

(73) Assignee: THE RESEARCH FOUNDATION FOR THE STATE UNIVERSITY OF NEW YORK, Albany, NY (US)

(21) Appl. No.: 19/721,676

(22) Filed: Jun. 26, 2026

Related U.S. Application Data
(63) Continuation of application No. PCT/US2024/062057, filed on Dec. 27, 2024.
(60) Provisional application No. 63/615,472, filed on Dec. 28, 2023.

(51) Int. Cl. H04B 10/70; G06N 10/40

(52) U.S. Cl. CPC H04B 10/70; G06N 10/40

(57) ABSTRACT

A Quantum-enabled Internet (QEI) including quantum-enabling networking architectures integrating advanced communication systems with long-distance quantum communication hardware and methods of operating the same. Using a quantum-network (QN) design paradigm, there is provided a physics-centric stack-based quantum network paradigm to govern the dynamics of multiple light-matter Hamiltonians across distant nodes. This QN network facilitates a fundamental long-distance quantum network service—that of high-visibility Hong-Ou-Mandel interference of telecom quantum states generated in two independent, telecom-compatible quantum light-matter interfaces separated by a distance. The QN paradigm design can be applied to demonstrate scalable long-distance QN services in an QN infrastructure, including the transmission of polarization entanglement created by high repetition sources of entangled photons and the storage of telecom polarization entanglement using remotely located quantum memories capable of heralding the storage of entanglement using non-demolition measurements and quantum state tomography.

This application claims priority under 35 U.S.C. § 119 to provisional application U.S. Ser. No. 63/615,472 filed Dec. 28, 2023, the entire contents of which are incorporated herein by reference for all purposes.

### CROSS REFERENCE TO RELATED APPLICATION

The present application was made with government support under contract number DE-SC0012704 awarded by the United States Department of Energy. The United States government has certain rights in the invention(s).

### FIELD OF THE INVENTION

The present disclosure relates to quantum-enabled communication networks generally and more specifically, to a quantum-enabled internet employing combination of software-defined and time-sensitive networking with quantum communications between quantum memories.

### BACKGROUND

Quantum networks include nodes capable of creating, processing, and storing quantum information linked via entanglement for transport. These networks present a non-monolithic approach toward quantum technology development, allowing for scalable and parallel development of communication, information processing, or metrology solutions.

Far from its internet aspirations, the development of quantum networks is yet ongoing. The early 2000s saw the advent of small-scale quantum entanglement and cryptography networks, now flowering into quantum network experiments targeting direct entanglement distribution, quantum-state transfer, and interference-mediated entanglement generation between quantum network nodes. Recently, efforts have been pushing towards larger scale quantum communication experiments targeting the development of quantum repeater and distributed quantum processing networks.

### SUMMARY

In some embodiments, rules are structured for quantum communication, analogous to the development of the Transmission Control Protocol/Internet Protocol (TCP/IP) protocol stack for classical computer networks. In some embodiments, the techniques disclosed herein deconstruct the process of quantum communication into resource-dedicated tasks or protocols.

The present disclosure is directed to quantum networks and specifically, systems and methods providing a quantum network framework including quantum network operations at protocol and design levels.

In one aspect of the present disclosure, there is provided a design, deployment, and implementation of an instance of a QEI network connecting QM-QFC atomic ensembles over a relatively long distance, e.g., 158 km, of deployed fiber. Using a novel QN design paradigm, there is demonstrated a stack-driven ubiquitous QN service, delivering long-distance, robust HOM interference with high visibility.

In some embodiments, a system for performing operations of quantum network is provided. The system includes quantum manipulating elements configured to directly manipulate and transport quantum information. The system also includes a central controller configured to synchronize and orchestrate operations of the quantum manipulating elements toward orchestrated actions, the orchestrated actions including at least generating entangled photons, quantum memory operations, and quantum measurements. The system also includes controllable instruments configured to interface with and drive the quantum manipulating elements, the controllable instruments translating control commands from the central controller to operational parameters of the quantum manipulating elements, the controllable instruments further configured to provide feedback from the quantum measurements to the central controller.

In some embodiments, the central controller is a general purpose computer, Field Programmable Gate Array, and/or another classical computer processor.

In some embodiments, the controllable instruments are grouped into subsystems and setups by functionality, and further include a clocking interface used to distribute timing information to the subsystems and the setups.

In some embodiments, the clocking interface further facilitates sub-synchronization resolution for coherent manipulation of quantum information.

In some embodiments, the controllable instruments are further configured to perform compensation between long-haul or distance connections to preserve coherence between disparate nodes over relevant time scales.

In some embodiments, the controllable instruments include at least signal generators, time-taggers, and oscilloscopes.

In some embodiments, the quantum manipulating elements include at least atoms, optical fibers, optical elements, and photodetectors.

In some embodiments, the central controller is further configured to manage the quantum information, use models that learn from data acquired from the quantum measurements to understand the quantum network, use the learned understanding for verification of the quantum network.

In some embodiments, a first set of application programming interfaces is used to interface the central controller with the controllable instruments, where the control commands from the central controller are communicated using one or more of the first set of application programming interfaces.

In some embodiments, the first set of application programming interfaces are operated independently of make and model of the controllable instruments.

In some embodiments, a second set of application programming interfaces is used to interface the central controller with one or more user-defined quantum network applications.

In some embodiments, the user-defined quantum network applications include at least distributed quantum gate operations, teleportation-based services, and HOM indistinguishability verification, and entanglement swapping.

In some embodiments, a method of operating quantum network is provided. The method includes configuring quantum manipulating elements to directly manipulate and transport quantum information. The method also include configuring a central controller to synchronize and orchestrate operations of the quantum manipulating elements toward orchestrated actions, the orchestrated actions including at least generating entangled photons, quantum memory operations, and quantum measurements. The method further includes configuring controllable instruments to interface with and drive the quantum manipulating elements, the controllable instruments translating control commands from the central controller to operational parameters of the quantum manipulating elements, the controllable instruments further configured to provide feedback from the quantum measurements to the central controller. The quantum network is operated via a hierarchy of interfacing the quantum manipulating elements with the controllable instruments, and interfacing the controllable instruments with the central controller.

In some embodiments, a method of quantum frequency conversion is generally described. The method can include receiving a first signal encoding a qubit, wherein the first signal has a first frequency. The method can further include receiving at least one laser beam. The method can further include configuring the at least one laser beam to generate at least one control beam. The method can further include merging the first signal with the at least one control beam to generate a second signal that encodes the qubit, wherein the second signal has a second frequency storing the second signal in a quantum memory device.

In some embodiment, the at least one laser beam can include a first laser beam having a third frequency and a second laser beam having a fourth frequency. Configuring the at least one laser beam can include configuring the first beam to generate a first control beam and configuring the second beam to generate a second control beam. Merging of the first signal with the at least one control beam can include merging the first signal with the first control beam and the second control beam to generate the second signal.

In some embodiments, the first frequency can be 780 nanometers (nm), the second frequency can be 1324 nm, the third frequency can be 795 nm, and the fourth frequency can be 1367 nm.

In some embodiments, configuring the first beam to generate the first control beam can include modulating the first beam. Configuring the second beam to generate the second control beam can include frequency locking the second beam.

In some embodiments, the first signal can be attenuated using an electro-optic modulator (EOM) to create a field envelope of the first signal.

In some embodiments, frequency locking the second beam can include operating an Indium gallium arsenide (InGaAs) balanced amplified photodetector to obtain an Optical-Optical Double Resonance (OODR) spectrum, scanning the second beam while keeping the first signal frequency locked, generating an error signal by modulating the second beam at a predefined frequency, and operating a proportional-integral-derivative (PID) controller to lock the second beam according to the error signal.

In some embodiments, merging the first signal with the at least one control beam can include resonantly coupling a first state of a diamond energy scheme to a third excited state of the diamond energy scheme. The diamond energy scheme can include the first state that is a ground state, a second state that is an excited state having higher energy than the first state, a third state higher that is an excited state having higher energy than the second state, a fourth state that is an excited state having higher energy than the third state. An input quantum field that receives the first signal can be connected by the first state and the third state of the diamond energy scheme and an output quantum field that outputs the second signal is connected by the second state and the fourth state of the diamond energy scheme. The first state can be coupled to the second state and the third state can be coupled to the fourth state of the diamond energy scheme.

In some embodiments, the at least one control beam can be filtered out to obtain the second signal.

In some embodiments, filtering out the at least one control beam can include using a Glan laser (GL) polarizer and at least one wavelength filter.

In some embodiments, the quantum memory device can be a room temperature vapor cell.

In some embodiments, a system of quantum frequency conversion is generally described. The system can include a combination optics apparatus and a frequency conversion apparatus. The combination optics apparatus can be configured to generate a first signal encoding a qubit, wherein the first signal has a first frequency. The combination optics apparatus can be further configured to generate at least one laser beam. The combination optics apparatus can be further configured to generate at least one control beam based on the at least one laser beam to. The frequency conversion apparatus can be configured to merge the first signal with the at least one control beam to generate a second signal that encodes the qubit, wherein the second signal has a second frequency. The frequency conversion apparatus can be further configured to store the second signal in a quantum memory device.

In some embodiments, the combination optics apparatus can include a first laser pump field configured to generate the first signal and at least one additional laser pump field configured to generate the at least one laser beam.

In some embodiments, the at least one laser beam can include a first laser beam having a third frequency and a second laser beam having a fourth frequency. The at least one additional laser pump field can include a second laser pump field configured to generate the first laser beam and a third laser pump field configured to generate the second laser beam.

In some embodiments, the combination optics apparatus can be configured to configure the first beam to generate a first control beam, configure the second beam to generate a second control beam, and the frequency conversion apparatus can be configured to merge the first signal with the first control beam and the second control beam to generate the second signal.

In some embodiments, the first frequency can be 780 nanometers (nm), the second frequency can be 1324 nm, the third frequency can be 795 nm, and the fourth frequency can be 1367 nm.

In some embodiments, the combination optics apparatus can be configured to configure the first beam to generate the first control beam by modulating the first beam and configure the second beam to generate the second control beam by frequency locking the second beam.

In some embodiments, the combination optics apparatus can be configured to attenuate the first signal using an electro-optic modulator (EOM) to create a field envelope of the first signal.

In some embodiments, to frequency lock the second beam, the combination optics apparatus can be configured to operate an Indium gallium arsenide (InGaAs) balanced amplified photodetector to obtain an Optical-Optical Double Resonance (OODR) spectrum, scan the second beam while keeping the first signal frequency locked, generate an error signal by modulating the second beam at a predefined frequency, and operate a proportional-integral-derivative (PID) controller to lock the second beam according to the error signal.

In some embodiments, to merge the first signal with the at least one control beam, the frequency conversion apparatus can be configured to resonantly couple a first state of a diamond energy scheme to a third excited state of the diamond energy scheme. The diamond energy scheme can include the first state that is a ground state, a second state that is an excited state having higher energy than the first state, a third state higher that is an excited state having higher energy than the second state, and a fourth state that is an excited state having higher energy than the third state. An input quantum field that receives the first signal can be connected by the first state and the third state of the diamond energy scheme and an output quantum field that outputs the second signal can be connected by the second state and the fourth state of the diamond energy scheme. The first state can be coupled to the second state and the third state can be coupled to the fourth state of the diamond energy scheme.

In some embodiments, the frequency conversion apparatus can be configured to filter out the at least one control beam to obtain the second signal.

In some embodiments, the frequency conversion apparatus can include a Glan laser (GL) polarizer and at least one wavelength filter configured to filter out the at least one control beam.

In some embodiments, the quantum memory device can be a room temperature vapor cell.

In some embodiment, a method for determining a degree of indistinguishability among qubits is generally described. The method can include receiving a first packet of photons from a first quantum memory. The method can further include receiving a second packet of photons from a second quantum memory. The method can further include determining a first arrival time of the first packet of photons. The method can further include determining a second arrival time of the second packet of photons. The method can further include determining a difference between the first arrival time and the second arrival time. The method can further include determining a coincidence rate between the first packet of photons and the second packet of photons. The method can further include determining a Hong-Ou-Mandel (HOM) visibility based on the coincidence rate and a difference between the first arrival time and the second arrival time. The HOM visibility can indicate the degree of indistinguishability between the first packet of photons and the second packet of photons.

In some examples, the first packet of photons can be received from the first quantum memory via a first optical path having a first distance and the second packet of photons can be received from the second quantum memory via a second optical path having a second distance different from the first distance.

In some examples, a polarization of the first packet of photons and a polarization of the second packet of photons can be compensated.

In some examples, a difference between a mean number of photons in the first packet of photons and a mean number of photons in the second packet of photons can be within a predefined threshold that maximizes the HOM visibility.

In some examples, the mean number of photons in the first packet of photons and the mean number of photons in the second packet of photons can be defined within one pulse temporal envelope.

In some examples, the first packet of photons and the second packet of photons can be received by a HOM detection system. The HOM detection system, the first quantum memory and the second quantum memory can be located in the same location.

In some examples, the same location including the first quantum memory, the second quantum memory and the HOM detection system can be a first location. The first quantum memory can receive the first packet of photons from a first light source located in a second location different from the first location. The second quantum memory can receive the second packet of photons from a second light source located in a third location different from the first location and different from the second location.

In some examples, a polarization of the first packet of photons and a polarization of the second packet of photons can be compensated using a plurality of optical components to direct macroscopic light to polarimeters for measurement. The plurality of optical components can be automatically removed to release the first packet of photons and the second packet of photons to a HOM detection system.

In some examples, determining the coincidence rate can include determining the first arrival time is within a period of time, determining the second arrival time is within the period of time, and in response to determining the first and second arrival times are within the period of time, recording a count of coincidence.

In some examples, the first arrival time can be a photon detection event among a first set of photon detection events in a first channel that receives the first packet of photons. The second arrival time is a photon detection event among a second set of photon detection events in a second channel that receives the second packet of photons. The count of coincidence can be among a number of counts of coincidence.

In some examples, the number of counts of coincidence can be a first number of counts of coincidence. A delay can be added to at least one of the first channel and the second channel. With the added delay, the first set of photon detection events can be monitored in the first channel and the second set of photon detection events can be monitored in the second channel. A second number of counts of coincidence can be determined from the monitoring with the added delay. A relationship between the first number of counts of coincidence and the second number of counts of coincidence can be determined.

In some examples, based on the relationship between the first number of counts of coincidence and the second number of counts of coincidence, the delay can be adjusted to minimize the coincidence rate, where minimizing the coincidence rate maximizes the HOM visibility and the degree of indistinguishability.

### BRIEF DESCRIPTION OF THE DRAWINGS

FIG. 1 conceptually depicts a quantum network including non-local Hamiltonians allowing hierarchical operations with fundamental processes defined as primitives (temporal modulations of Hamiltonian parameters) that are used to establish network protocols yielding services as outcomes in accordance with embodiments herein;

FIG. 2 generally depicts an optical infrastructure between two nodes that uses four optical fibers (e.g., 70 km) for communicating quantum information and for time synchronization and classical data signals according to an embodiment herein;

FIG. 3 depicts a quantum-enabling (QE) architecture abstracting the implementation of QE processes orchestrated by a control plane and executed at a quantum enabling interface plane where control trickles down to a quantum data plane resulting in forwarding of quantum information;

FIG. 4A depicts a QM-QFC setup implementing frequency locking of a 1367 nm laser using an optical-optical double resonance (OODR) laser stabilization setup and the creating of a field envelope of a 780 nm signal according to an embodiment;

FIG. 4B depicts a flowchart of an example QM-QFC process according to an embodiment;

FIG. 5A is a plot depicting example input and output pulses detected by the SNSPDs used to estimate the efficiency of the QFC process in an embodiment;

FIG. 5B is a plot depicting an example measured number of photons of QFC pulses at 1324 nm (diamonds) and signal-to-noise ratio (SNR) at the detector (triangles) as a function of the mean photon number in the 780 nm input pulse for Alice and Bob nodes;

FIGS. 6A-6B is a schematic diagram depicting the physical network nodes forming the QEI according to the embodiment herein;

FIG. 6C depicts a flowchart of an example process that can be performed by a measurement node according to an embodiment;

FIG. 7A is a plot depicting a histogram of jitter events in the 70 km shared clock network, where a node (e.g., referred to as Charlie) is a master clock in a tree configuration connecting two nodes (e.g., referred to as Alice and Bob) in an embodiment;

FIG. 7B is a plot depicting a histogram of jitter events in the complete 70 km QN link between two nodes after a number of hours of integration time in an embodiment;

FIG. 7C depicts a distribution of polarization states between the two nodes, with compensation executed every 15 minutes over an integration period of 12 hours including upper plots showing a close-up of a stable time segment (e.g., around midnight) and a period with more fluctuations (e.g., early morning);

FIG. 7D depicts a distribution of the time needed to stabilize the transmitted PS to desired state |H [symbol] with the inset showing no correlation to the time of the day was observed during an observation period;

FIG. 7E is a plot depicting a free-drift time for which the polarization fidelity is preserved after the compensation is performed (top) and a plot depicting polarization fidelity measurements with activated feedback every pre-defined number of minutes during a collection time in hours (bottom) according to example embodiment;

FIGS. 8A-8B depict an exemplary implementation of the QE interface plane: the QEI testbed between two nodes has two identical co-located nodes at one site and a third node at the second site; and shows the devices of each node, coded by functionality, their connectivity, and their grouping in quantum optical system setups and quantum optical subsystems in an embodiment;

FIGS. 9A-9B depict the HOM protocol and the network primitives executed by active QEIP components in an embodiment;

FIGS. 10A-10B depict an overview of a stack-driven quantum memory QN including three optical network layers, e.g., a classical control network layer for user-defined control and fast feedback; a quantum-enabling network layer supporting time, phase, and polarization analog measurements; and a quantum network layer, including room temperature quantum memories, qubit detection systems, and photonic quantum signals transmission according to an embodiment;

FIG. 11A depicts an orchestrated sequence for QM QFC generation and long-distance HOM interference in an embodiment;

FIG. 11B depicts a 1324 FWM HOM pulsed quantum interference experiment operated for the 20 km QEI configuration at a node with the inset showing a continuous-wave HOM in an embodiment;

FIGS. 11C-11E depict plots of the 1324 FWM HOM pulsed quantum interference experiments operated for the long distance QEI configuration at the example sites with the measurements done for different mean photon numbers at the exit of the frequency converters in an embodiment; and

FIG. 12 is a flow diagram illustrating a method of operating quantum network in some embodiments.

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or ±0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

The present disclosure relates to a new physics-centric stack-based Quantum Network (QN) paradigm using state-of-the-art classical and quantum communication systems. A methodology is implemented that follows contemporaneous networking principles while considering the unique systematic and physical demands of an Internet enabled to execute quantum operations across a collection of networked Hamiltonians: a Quantum-Enabled Internet (QEI). Optical fiber-based networks are used to build high-repetition-rate, long-distance QNs, offering a versatile platform synergizing with the established telecommunication infrastructure, enhancing cost-effectiveness. Additionally, there is implemented time-evolving light-matter interconnects based on atomic systems with energy transitions at telecom wavelengths, facilitating efficient quantum information transfer across QN nodes. The present disclosure further demonstrates the concept of a quantum-enabling architecture that merges advanced communication management principles and high-fidelity QN services. In some embodiments, a long-distance quantum network service can be provided, for example, employing Hong-Ou-Mandel Interference of telecom photons produced in independent quantum memories separated by a long distance, e.g., 158 km.

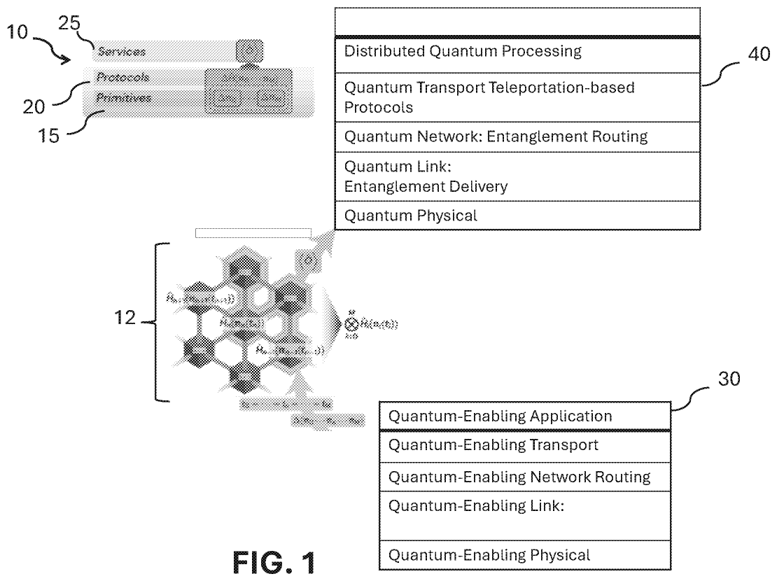

As shown in FIG. 1, in some embodiments, to build an instance of a long-distance measurement-based QEI, the QN paradigm adopts an operational hierarchy 10 correspondent to that of classical networks. The abstraction considers QNs as a collection of dynamic Hamiltonians 12 located at the QN nodes and the QN protocols as QN processes obtained by simultaneously driving and measuring sets of remotely-located Hamiltonians 12. The complex processes of a large QN are broken down into QN primitives 15, which perform temporal manipulations of Hamiltonian parameters for QN nodes' operations. These primitives are grouped into QN protocols 20 that guide the evolution of the entire network. Outcomes deriving from quantum observables associated with fundamental QN protocols (e.g., long-distance HOM interference or entanglement distribution and swapping) are defined as QN services 25.

In some embodiments, to implement quantum protocols and develop quantum communication services and standards, a Quantum-Enabling (QE) Protocol Stack 30 is devised that includes deterministic QE-protocols needed to prepare, control, and monitor quantum network operations at every step of the communication process. This QE protocol stack 30 is a hierarchy defining: a QE Application layer; a QE Transport layer; a QE Network Routing layer; a QE Link layer; and a QE Physical layer. QE protocols are responsible for physically realizing QN primitives and protocols. This establishes the guidelines for using ancillary classical networks to support QN services and to develop the Quantum Internet stack 40. The Quantum Internet stack 40 is a hierarchy defining: a Distributed Quantum Processing layer; a Quantum Transport Teleportation-based protocol layer; a Quantum Network Entanglement Routing layer; a Quantum Link: Entanglement Delivery layer; and a Quantum Physical layer.

More particularly, with reference to FIG. 1, the quantum network (QN) includes non-local Hamiltonians 12 allowing hierarchical operations, with fundamental processes defined as primitives. These primitives perform temporal modulations of Hamiltonian parameters-establish network protocols that yield services as outcomes. These protocols may be organized into the quantum protocol stack 40 for quantum communication networks. Realizing this concept uses ancillary structures to enable robust construction of quantum primitives and protocols. These quantum-enabling processes can be grouped into the supporting protocol stack 30. Fundamental quantum-enabling protocols involve preparing and controlling physical parameters corresponding to Hamiltonian parameters and distributing a global sense of time throughout the network.

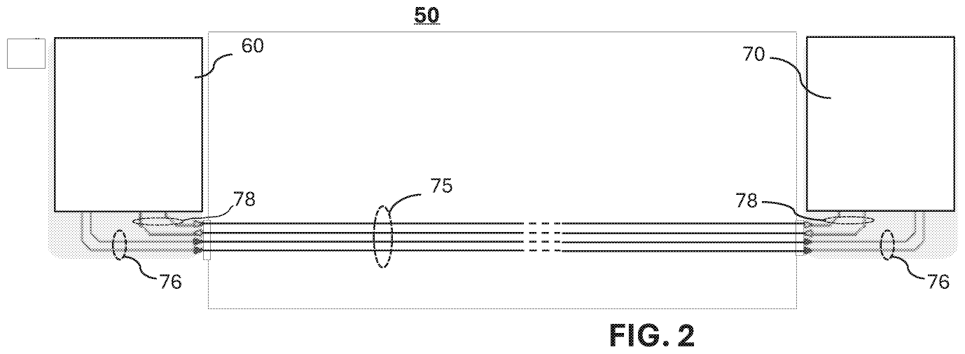

As shown in FIG. 2, the present disclosure further provides a Quantum-Enabling Network Architecture 50 for employing a combination of software-defined and time-sensitive networking with quantum communications between quantum memories, including the provision of a fundamental long-distance quantum network service employing Hong-Ou-Mandel (HOM) Interference of telecom photons produced in two independent quantum memories separated by a distance. In a non-limiting, illustrative example, two QN nodes 60, 70 each having a respective independent quantum memory are separated by a distance (non-limiting), e.g., of 158 km. In the embodiment shown in FIG. 2, the Quantum-Enabling Network architecture 50 includes two QE nodes 60, 70 separated by a distance and connected by an optical fiber infrastructure 75, e.g., using four 70 km commercial single-mode optical fibers. One pair of fibers 76 is for quantum information, and another pair of fibers 78 is for time synchronization and classical data signals. The Alice, Bob, and Dave quantum nodes are co-located at a node, e.g., node 60 (also referred to as a first node or first site associated with a networked entity at a first location), with the Charlie node at node 70 (also referred to as a second node or second site associated with a networked entity at a second location). Additional fiber loops at nodes 60 and 70 allow phase independence in the quantum channels.

In an embodiment, the Quantum-Enabled Internet (QEI) operates in accordance with a network managing policy characterized by separation between control and forwarding operations implementing quantum hardware. Separated and centralized control allows for the manipulation of non-local operations involving entanglement. Quantum hardware, or devices, are forwarding elements and would be part of the forwarding plane, however, the manipulation, from the control plane, of quantum information is layered.

The qubit medium in networks are photons. Manipulation of photon qubits (or photonic qubits) is realized by absorptive and emitting systems with energy levels (such as atoms, ions). The manipulation of these systems is realized via electromagnetic fields which are driven by controllable instruments such as signal generators. Thus, a controllable quantum device includes the systems capable of manipulating qubits and the control elements associated. However, it is useful to separate the control elements and qubit manipulating (forwarding) elements to distinguish between the control operation and the resulting quantum phenomena/behavior. This is useful as it gives the flexibility to modify the control elements while preserving the quantum specification. This separation also acknowledges that qubit manipulation is performed via an intermediate or interface. This results in the forwarding plane splitting into the quantum-enabling interface plane and the quantum data-plane.

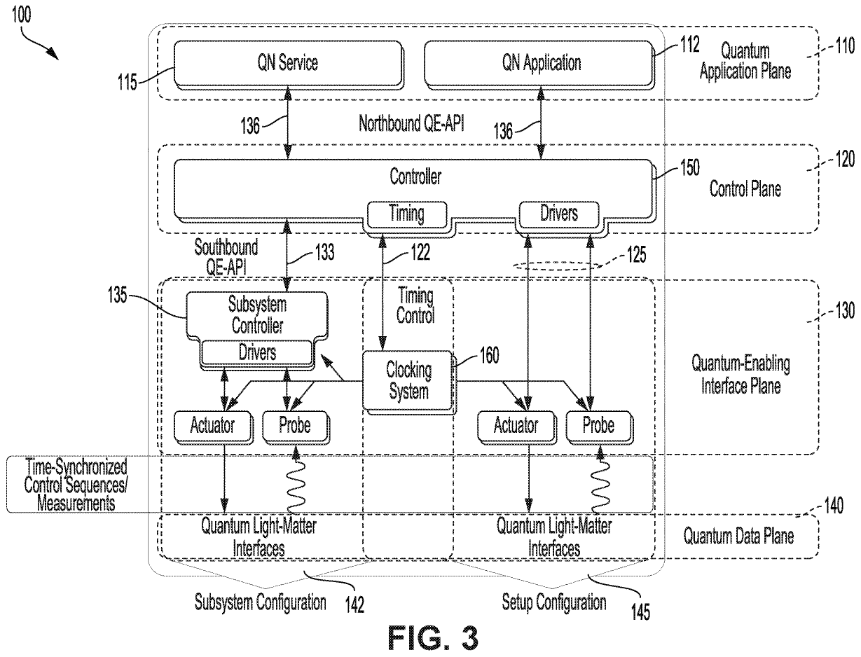

According to embodiments herein, FIG. 3 depicts a Quantum-enabling network architecture 100 in which takes place the execution of QE protocols and the operation of a Quantum-Enabled Internet (QEI) as understood through an architectural model. The QEI architecture 100 includes four coexisting planes: a Quantum Application Plane (QAP) 110, a Control Plane (CP) 120, a Quantum-Enabling Interface Plane (QEIP) 130, and a Quantum Data Plane (QDP) 140. The QEI architecture 100 abstracts the implementation of QE processes which are orchestrated by the control plane (CP) 120 and executed at the quantum-enabling interface plane (QEIP) 130. Control thus trickles down to the quantum data plane (QDP) 140, resulting in forwarding of quantum information. Control commands and measurements are exchanged between planes via quantum-enabling application programming interfaces.

The QDP 140 is responsible for manipulating and transporting quantum information. As timing control signals 122 and driver control signals 125 from the CP 120 trickle down through the QEIP 130, the QDP 140 enables the operation of qubit-manipulating media toward orchestrated actions, such as generating entangled photons, quantum memory operations, and quantum measurements. QN primitives and protocols are realized in the QDP. By way of non-limiting examples, QDP 140 includes quantum manipulating elements or components such as, but not limited to, atoms, optical fibers, optical elements, and photodetectors, configured to directly manipulate and transport quantum information.

The QEIP 130 of the QN operation, in some embodiments, includes all control and interfacing elements for the multitude of systems forming the QN 100. Control and interfacing elements are grouped by functionality or types of device organizations into subsystems configuration 142 and setups configuration 145. In some embodiments, setups configuration 145 includes configurations of devices (e.g., drivers of actuators and/or probes) that take direct command sequences from their node controller to operate. Devices (e.g., drivers of actuators and/or probes) of subsystems configuration 142 are operated via an intermediate controller (e.g., computer/Field Programmable Gate Array (FPGA)) hosting control software and/or drivers. At the individual node level, a node controller is an entity that coordinates the operations of all node components, either by directly orchestrating ensembles of devices or by interfacing with subsystem controllers to perform operations. Elements within setup configurations 145 are managed by the central network controller 150. Within subsystem configurations 142, the central network controller 150 delegates control to task-specific controllers. Additionally, to maintain temporal accordance across the entire network, the QEIP 130 includes or uses a precise clocking system 160 providing a clocking interface to distribute timing information to setups 145 and subsystems 142. In an embodiment, QEIP 130 utilizes a White-Rabbit (WR) network to establish network clocking with a temporal jitter shorter than the temporal duration of the photons propagating through the QN. By way of non-limiting examples, QEIP 130 includes controllable instruments configured to interface with and drive the quantum manipulating elements. The controllable instruments translate control commands from central controller to operational parameters of the quantum manipulating elements. The controllable instruments are further configured to provide feedback from the quantum measurements to the central controller. Examples of the controllable instruments include, but are not limited to, signal generators, time-taggers, and oscilloscopes.

The CP 120 is centralized and responsible for managing and forwarding quantum information via the QEIP 130. Southbound Quantum-Enabling (QE) Application Programming Interfaces (APIs) 133 enable communication from the CP 120 to the QEIP 130, allowing for non-local entanglement-based operations. Southbound Quantum-Enabling (QE) Application Programming Interfaces (APIs) 133 are also referred to as a first set of application programming interfaces. For example, a first set of application programming interfaces are used to interface the central controller with the controllable instruments, where the control commands from the central controller are communicated using one or more of the first set of application programming interfaces. Northbound QE-APIs 136 allow users or higher-level functions to interface with the central controller 160 and obtain a network-wide view of available capabilities. Northbound QE-APIs 136 are also referred to as a second set of application programming interfaces. The second set of application programming interfaces can be used to interface the central controller with one or more user-defined quantum network applications. The user-defined quantum network applications include at least distributed quantum gate operations, teleportation-based services, and HOM indistinguishability verification, and entanglement swapping. Southbound Quantum-Enabling (QE) Application Programming Interfaces (APIs) 133 refer to APIs that interface with operations at the QEIP 130 level, e.g., with quantum subsystems (also referred to as subsystem configurations 142), and quantum setups (using drivers for directly interfacing with devices). Quantum setups are also referred to setups configuration 145. Northbound QE-APIs 136 refer to APIs that interface with operations at the Quantum Application Plane 110 level. In some embodiments, the control plane (CP) 120 controls and makes decisions. The CP 120 has an understanding of the fundamental quantum systems, how the control is directly responsible for the quantum systems, and the overall network operation. The CP 120 uses models which learn from data acquired from measurement to develop an understanding of the system (e.g., distribution-learning/parameter-estimation using stochastic variational inference or conformal prediction) and use them to inform device and network control and verification. CP 120 includes a central controller configured to synchronize and orchestrate operations of the quantum manipulating elements toward orchestrated actions. Example of the orchestrated actions include, but are not limited to, generating entangled photons, quantum memory operations, and quantum measurements.

### Quantum-Enabling Application Programming Interfaces

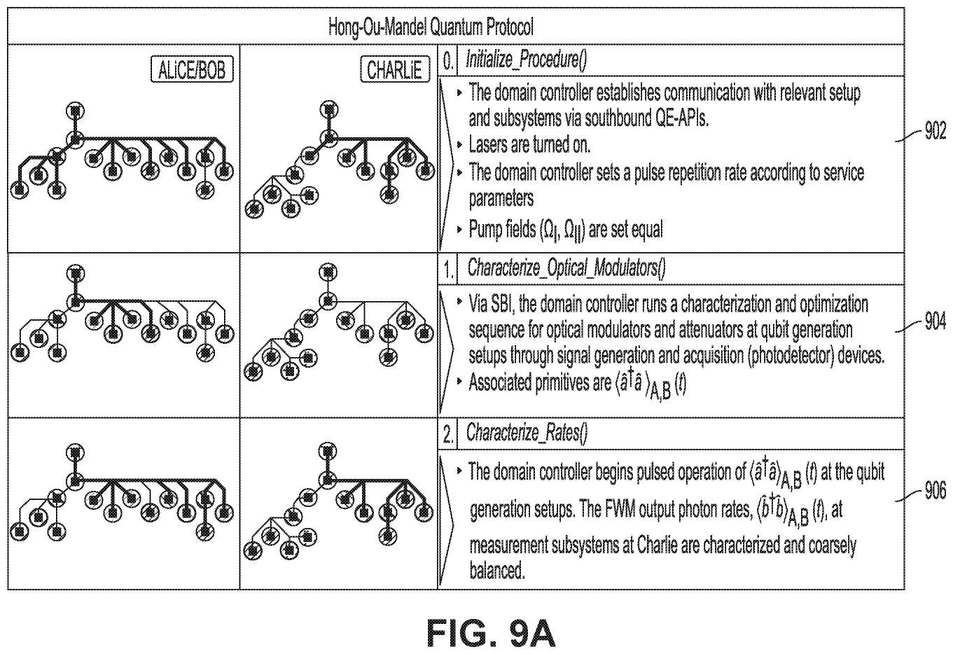

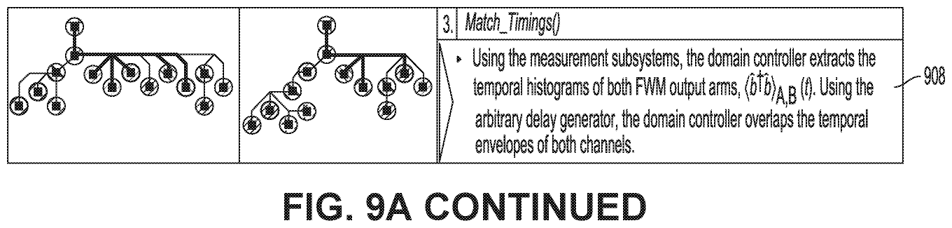

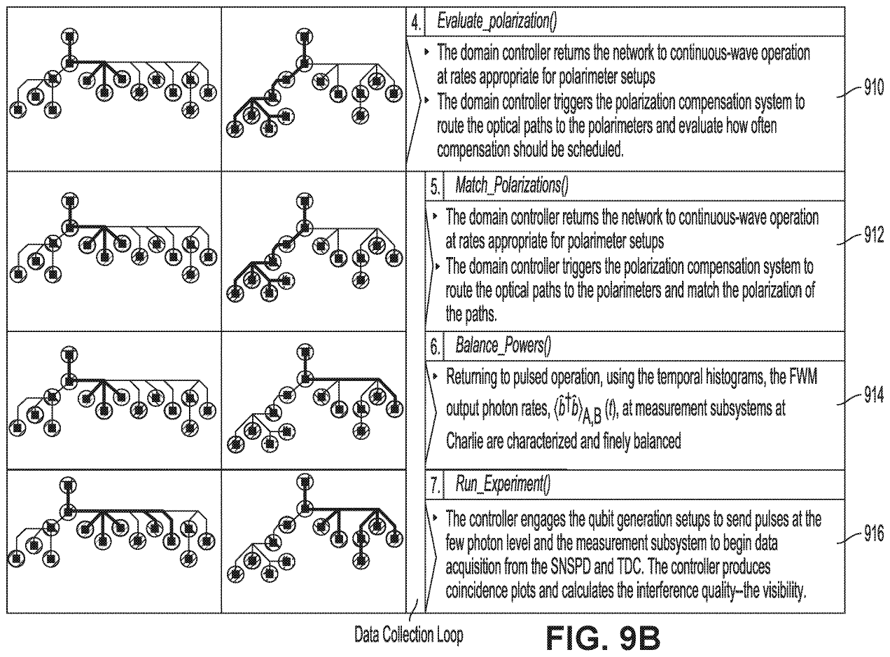

With more particularity, in view of FIG. 3, the Quantum-Enabling (QE) Application Programming Interfaces (APIs) 133, 136 define how the control plane 120 communicates with the QE interface plane 130 and quantum application plane 110. The southbound QE-APIs 133 include drivers that handle communication between the controller 150 and all devices and sub-system controllers 135 on the QE interface plane 130. In some embodiments, these drivers are python-written and based on the Virtual Instrument Software Architecture (VISA) protocol and custom device communication standards. Depending on functionality, these libraries follow a facade design pattern to control network devices homogeneously. By way of example, shown in FIGS. 9A-9B are eight QE-protocol step procedures built from these drivers.

The northbound QE-APIs 136 are, e.g., Python commands written on top of the eight-protocol procedure. They can extract measurement and status information, including mean photon number, temporal photon shapes, and HOM visibility, along all procedure steps. A dashboard/GUI is developed to use the northbound QE-APIs to present relevant information as the QN protocol is executed.

The QAP 110 provides the facade for all network operations, allowing them to be addressed independently of lower-level operations. The QAP 110 encompasses higher-level entanglement-based applications 112, such as distributed quantum gate operation and teleportation-based services, and lower-level QN services 115, such as HOM indistinguishability verification or entanglement swapping. This enables user-defined network operation and the development of more complicated quantum network operations.

Thus, while having all the implementation details, focusing on different planes gives a different, and useful perspective of network operation. The QDP 140 is measurement-oriented and describes the fundamental quantum operations. The QEIP 130 describes the operation of the controlling hardware used for implementation. The CP 120 describes an understanding of the system in terms of mathematical models and the control variables associated to the QEIP 130. The QAP 110 gives a high-level understanding of the operation.

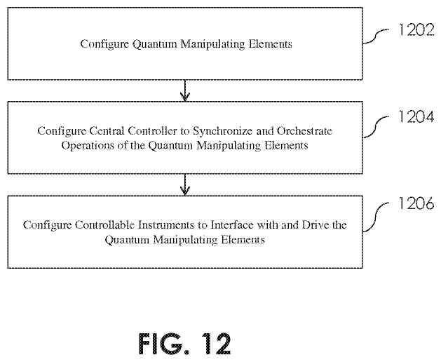

In some embodiments, as described above and in further detail below, a method of operating quantum network is provided. FIG. 12 is a flow diagram illustrating a method or operating quantum network in some embodiments. At 1202, the method includes configuring quantum manipulating elements to directly manipulate and transport quantum information. In some embodiments, the quantum manipulating elements include at least atoms, optical fibers, optical elements, and photodetectors.

At 1204, the method also includes configuring a central controller to synchronize and orchestrate operations of the quantum manipulating elements toward orchestrated actions. In some embodiments, the orchestrated actions include at least generating entangled photons, quantum memory operations, and quantum measurements.

At 1206, the method further includes configuring controllable instruments to interface with and drive the quantum manipulating elements. In some embodiments, the controllable instruments translate control commands from the central controller to operational parameters of the quantum manipulating elements. In some embodiments, the controllable instruments are further configured to provide feedback from the quantum measurements to the central controller.

In some embodiments, the quantum network is operated via a hierarchy of interfacing the quantum manipulating elements with the controllable instruments, and interfacing the controllable instruments with the central controller, e.g., interfacing of different planes as described herein. In some embodiments, the controllable instruments are grouped into subsystems and setups by functionality, and further include a clocking interface used to distribute timing information to the subsystems and the setups. In some embodiments, the clocking interface further facilitates sub-synchronization resolution for coherent manipulation of quantum information. In some embodiments, the controllable instruments are further configured to perform compensation between distance (e.g., long-haul) connections to preserve coherence between disparate nodes over relevant time scales. In some embodiments, the controllable instruments include at least signal generators, time-taggers, and oscilloscopes. In some embodiments, the central controller is further configured to manage the quantum information, use models that learn from data acquired from the quantum measurements to understand the quantum network, use the learned understanding for verification of the quantum network. In some embodiments, the central controller includes one or more classical computers or computer processors.

In some embodiments, the method also includes using or configuring a first set of application programming interfaces to interface the central controller with the controllable instruments, where the control commands from the central controller are communicated using one or more of the first set of application programming interfaces. In some embodiments, the first set of application programming interfaces are operated independently of make and model of the controllable instruments. In some embodiments, the method also includes using or configuring a second set of application programming interfaces, used to interface the central controller with one or more user-defined quantum network applications. In some embodiments, the user-defined quantum network applications include at least distributed quantum gate operations, teleportation-based services, and HOM indistinguishability verification, and entanglement swapping.

The Quantum-Enabling Network architecture 50 of FIG. 2 facilitates the execution of fundamental quantum services and protocols described above, in addition to supporting entanglement distribution and quantum state teleportation across extended distances leveraging the telecommunication fiber infrastructure 75. What is now described is an embodiment of the implementation of a QEI service using the QEI network architecture 100 of FIG. 3 using a long-distance high-visibility HOM interference of telecom photonic qubits produced in two independent light-matter systems at nodes 60, 70 (at respective separated first and second sites) connected by a long distance, e.g., 158 kilometers, of fiber.

### Quantum Data Plane Implementation

For the QDP 140 implementation of FIG. 3, there is chosen a quantum system capable of high-fidelity production of quantum states and transfer of telecom-compatible quantum states, including (i) field-deployable quantum-memory-compatible quantum frequency converters (QM-QFC) operating at telecom wavelengths and (ii) HOM interference stations used to evaluate the interoperability among the QM-QFCs and the quantum interference visibility of qubits after transmission over long distances. These systems are distributed among the nodes 60, 70 at the respective separated first and second locations.

### Light-Matter Quantum Interfaces: Quantum-Memory-Compatible Quantum Frequency Converters

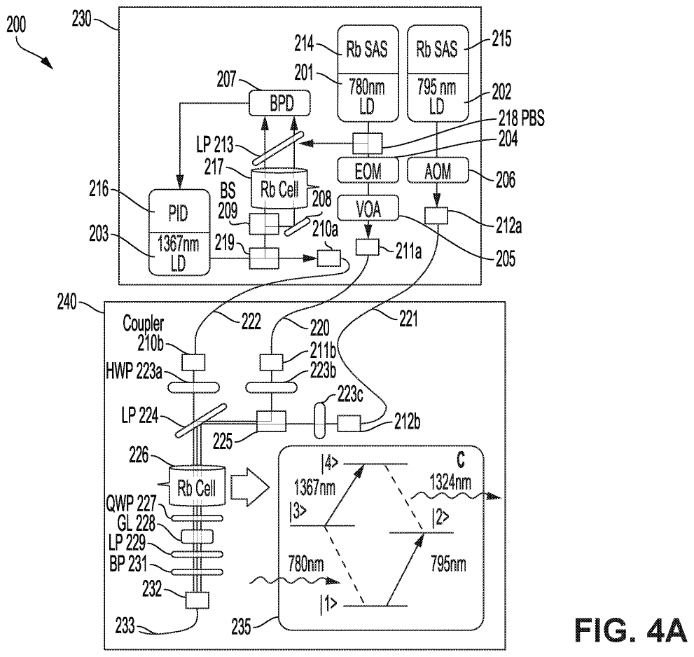

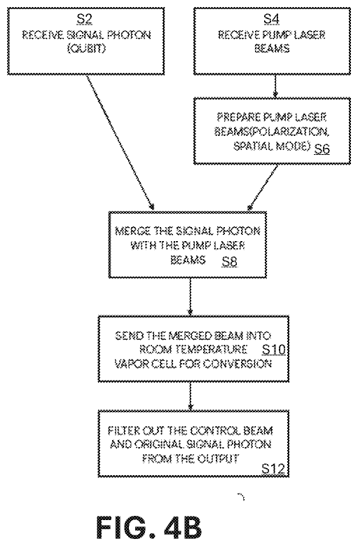

In the Quantum-Memory-Compatible Quantum Frequency Converters (QM-QFC) described in the present disclosure, a 780 nm laser input signal is converted to 1324 nm signal via four-wave mixing (FWM) with two pumping fields at 795 nm and 1367 nm. FIG. 4A shows an embodiment of an example apparatus that can implement the QM-QFC described in the present disclosure. The 780 nm signal is combined with the 795 nm pump in a polarizing beam splitter and then combined with the 1367 nm pump light by a long pass filter. A half-wave plate (HWP) and a quarter-wave plate (QWP) are used before a Glan laser Polarizer (GL) to compensate for birefringence. An InGaAs photodetector is used to detect the generated 1324 nm field. The 1367 nm laser is locked using an Optical-Optical Double Resonance (OODR) laser stabilization setup. After the cell the pump beams are filtered out by the GL polarizer and wavelength filters. As shown in FIG. 4A, a four-level diamond atomic scheme 235 is used for frequency conversion.

In an embodiment, the frequency locking of the 1367 nm laser makes use of the 5S_{1/2}→5P_{3/2} transition (1→3) at 780 nm and the 5P_{3/2}→6S_{1/2} transition (3→4) at 1367 nm. The 780 nm optically pumps the 5P_{3/2} level, and it is locked to the 5S_{1/2}F=3→5P_{3/2}F′=4 transition via saturated absorption spectroscopy (SAS). For OODR, the 1367 nm laser is counter-propagating to the 780 nm laser beam in a 7 cm rubidium cell maintained at 60 °C. An InGaAs balanced amplified photodetector obtains the OODR spectrum when scanning the 1367 nm laser while keeping the 780 nm laser locked. An error signal is generated by modulating the 1367 nm laser at 100 kHz, and a PI controller locks the laser according to the error signal.

The input 780 nm weak coherent state simulates the readout qubits from quantum memories. The input field resonantly couples the ground state |1 [symbol] (5S_{1/2}, F=3) to the excited state |3 [symbol] (5P_{3/2}, F=4). The 795 nm pump I couples the ground state |1 [symbol] to the excited state |2 [symbol] (5P_{1/2}, F=3), and the 1367 nm pump II couples |3 [symbol] to a higher excited state 4 (6S_{1/2}, F=3). The conversion system is governed by the Four-Wave Mixing (FWM) Hamiltonian according to equation (1) as follows:

$${\tilde{H}}_{F W M} = {ℏΔ}_{a} {\hat{a}}^{†} \hat{a} + {ℏΔ}_{b} {\hat{b}}^{†} \hat{b} + {\sum }_{i = 1}^{N} [ {ℏΔ}_{2} {σ}_{22}^{i} + {ℏΔ}_{3} {σ}_{33}^{i} + {Δ}_{4} {σ}_{44}^{i} + ( ℏ \frac{{Ω}_{I}}{2} {σ}_{21}^{i} + ℏ \frac{{Ω}_{I I}}{2} {σ}_{43}^{i} + ℏ {g}_{p} \hat{a} {σ}_{31}^{i} + ℏ {g}_{QFC} \hat{b} {σ}_{42}^{i} + h . c . ) ] \qquad ( 1 )$$

where N is the number of atoms in the ensemble, â^{†} is the creation operator of the input probe field, \hat{b}^{†} is the creation operator for the QFC output field connecting states |2 [symbol] and |4 [symbol] , Ω_{I} and Ω_{II} are the Rabi frequencies of the two pumps fields, gₚ and g_{QFC} are the dipole-coupling strengths for the input and the output quantum fields, σⱼₖ is the jkth element of the four-dimensional atomic operator. The Δᵢ's are the single photon detunings. By the input-output formalism, one can show the frequency conversion from the 780 nm input field to the 1324 nm output field follows the linear relation

$$〈 {\hat{b}}_{out}^{†} ( t ) {\hat{b}}_{out} ( t ) 〉 = {\vert η ( 0 ) \vert}^{2} 〈 {\hat{a}}_{in}^{†} ( t ) {\hat{a}}_{in} ( t ) 〉$$

where |η(0)|² is a constant conversion efficiency independent of the mean input photon number (see SM for the complete derivation). Both rubidium vapor cells contain naturally abundant ⁸⁵Rb and ⁸⁷Rb and are magnetically shielded. For each of the QFC, the modification of the set of parameters of the system π_{Alice/Bob}={Ω_{I}(t), Ω_{II}(t), (â^{†}(t)â(t))} constitutes the QN primitives. Details of the apparatus and structures implementing QM-QFC are described below.

Referring to FIG. 4A, an example system 200 for the quantum frequency conversion described in the present disclosure. In one embodiment, a node, e.g., node 60, can include two identical system 200. System 200 can implement a quantum memory-quantum frequency converter (QM-QFC) that converts a first signal having a first frequency to a second signal having a second frequency. The first signal can be a packet of photons encoding a set of qubits including at least one qubit, and the second signal can be a packet of photons encoding the same set of qubits as the first signal. As shown in FIG. 4A, system 200 can include a combination optics apparatus 230 and frequency conversion apparatus 240. Combination optics apparatus 230 can be a configuration of devices including at least a laser diode (LD) 201, an LD 202, an LD 203, an electrical-optical modulator (EOM) 204, a variable optical attenuator (VOA) 205, an acousto-optic modulator (AOM) 206, a balanced photodetector (BPD) 207, an optical component 208, a beam splitter (BS) 209, at least one optical couplers 210a, 211a, 212a, a longpass (LP) filter 213, at least one saturated absorption spectroscopy (SAS) 214, 215, and a proportional-integral-derivative (PID) controller 216, a quantum memory 217 and at least one polarizing beam splitter (PBS) 218, 219.

SAS 214 and LD 201 can form a laser pump field configured to output a laser as a signal having a frequency of 780 nanometers (nm). SAS 214 can be a Rb SAS used in conjunction with LD 201 for frequency stabilization. PBS 218 can be configured to split the 780 nm signal outputted from LD 201 into two orthogonal polarization components—a transmitted beam and a reflected beam. The transmitted beam can be provided to EOM 204 and the reflected beam can be provided to LP filter 213. EOM 204 can be configured to create a field envelope of the 780 nm signal (or the transmitted beam received from PBS 218) and VOA 205 can be configured to attenuate the 780 nm signal within the created envelope. The attenuated 780 nm signal can be outputted from combination optics apparatus 230, via optical coupler 211a, as a first signal 220.

SAS 215 and LD 202 can form a laser pump field configured to output a laser as a signal having a frequency of 795 nm. SAS 215 can be a Rb SAS used in conjunction with LD 202 for frequency stabilization. AOM 206 can be configured to modulate the 795 nm signal outputted by LD 202. The modulated 795 nm signal can be outputted from combination optics apparatus 230, via optical coupler 212a, as a first control beam 221.

LD 203 can be a laser pump field configured to output a laser as a signal having a frequency of 1367 nm. PBS 219 can be configured to split the 1367 nm signal outputted from LD 203 into two orthogonal polarization components—a transmitted beam and a reflected beam. The transmitted beam can be provided to optical coupler 210a and the reflected beam can be provided to BS 209. BS 209 can be configured to split the reflected beam into two beams-a first beam being provided to quantum memory 217 and a second beam being provided to optical component 208. Optical component 208 can be, for example, a mirror or an optical switch, configured to modulate the second beam. In one embodiment, optical component 208 can modulate the second beam at 100 kilohertz (kHz). Optical component 208 can route the modulated second beam to quantum memory 217. In one embodiment, quantum memory 217 can be a 7 centimeter (cm) Rb cell maintained at 60 °C. Quantum memory 217 can provide both the first beam and the modulated second beam to LP filter 213.

The first beam and the modulated second beam, along with the reflected beam of the 780 nm signal from PBS 218, can be routed to BPD 207 by LP filter 213. BPD 207 can receive the combination of beams from LP filter 213 and obtain an Optical-Optical Double Resonance (OODR) spectrum of the 1367 nm signal by scanning the 1367 nm signal while keeping the 780 nm signal phase or frequency locked. In one embodiment, BPD 207 is an Indium gallium arsenide (InGaAs) balanced amplified photodetector. The OODR spectrum obtained by BPD 207 can indicate an error between the 1367 nm signal and the 780 nm signal, and this error can be outputted to PID controller 216 as an error signal. PID controller 216 can phase or frequency lock the 1367 nm signal according to the error signal. This error and locking loop can be performed to ensure that the 1367 signal being outputted by combination optics apparatus 230 are phase or frequency locked with the 780 nm signal. The locked 1367 nm signal can be outputted from combination optics apparatus 230, via optical coupler 210a, as a second control beam 222.

Frequency conversion apparatus 240 can be a configuration of devices including at least one optical couplers 210b, 211b, 212b, 232, at least one half-wave plate (HWP) 223a, 223b, 223c, at least one LP filter 224, 229, a PBS 225 (which can also function as a combiner), a quantum memory 226, a quarter-wave plate (QWP), a Glan laser (GL) polarizer 228, and a bandpass (BP) filter 231. Optical couplers 210b, 211b, 212b can receive second control beam 222, first signal 220, and first control beam 221, from optical couplers 210a, 211a, 212a, respectively. HWP 223a can be an optical device configured to control the polarization of second control beam 222 by introducing a phase difference of half a wavelength. HWP 223b can be an optical device configured to control the polarization of first signal 220 by introducing a phase difference of half a wavelength. HWP 223c can be an optical device configured to control the polarization of first control beam 221 by introducing a phase difference of half a wavelength.

PBS 225 can combine or merge first signal 220 with first control beam 221 from HWPs 223b, 223c. LP filter 224 can be configured to pass the second control beam 222 from HWP 223a to quantum memory 226, and route the merged signal from PBS 225 to quantum memory 226. Second control beam 222 and the merged first control beam 221 and first signal 220 can be combined at quantum memory 226. Quantum memory 226 can be a room temperature Rb vapor cell. The combination at quantum memory 226 can cause storage of a second signal quantum memory 226, where the second signal has a frequency of 1324 nm, and 1324 nm can be a frequency compliant with telecommunications.

QWP 227 can be situated between quantum memory 226 and GL polarizer 228 to compensate for birefringence. In some embodiments, additional HWP accompanying QWP 227 can be situated between quantum memory 226 and GL polarizer 228. GL polarizer 228, LP filter 229 and BP filter 231 can work in conjunction to filter out first control beam 221 and second control beam 222 to obtain second signal 233 having frequency of 1324 nm, but encodes the same qubits as those encoded by the first signal 220 (or the 780 nm signal). Optical coupler 232 can output the second signal 233.

FIG. 4B depicts a flowchart of an example QM-QFC process 280 according to an embodiment. Process 280 can include one or more operations, actions, or functions as illustrated by one or more of blocks S2, S4, S6, S8, S10 and/or S12. Although illustrated as discrete blocks, various blocks can be divided into additional blocks, combined into fewer blocks, eliminated, performed in different order, or performed in parallel, depending on the desired implementation.

Process 280 can begin at block S2 and/or block S4. At block S2, a QM-QFC system can receive a signal photon encoding qubits, such as a first signal encoding a qubit and the first signal has a first frequency. At block S2, a QM-QFC system can receive pump laser beans, such as at least one laser beam. Process 280 can proceed from block S4 to block S6. At block S6, the QM-QFC system can prepare pump laser beams such as adjusting polarization and spatial modes, such as by configuring the at least one laser beam to generate at least one control beam. In one embodiment, the at least one laser beam comprises a first laser beam having a third frequency and a second laser beam having a fourth frequency. The QM-QFC system can configure the at least one laser beam by configuring the first beam to generate a first control beam and configuring the second beam to generate a second control beam. The QM-QFC system can merge the first signal with the at least one control beam comprises merging the first signal with the first control beam and the second control beam to generate the second signal. In one embodiment, the first frequency is 780 nanometers (nm), the second frequency is 1324 nm, the third frequency is 795 nm, and the fourth frequency is 1367 nm.

In one embodiment, the QM-QFC system can configure the first beam to generate the first control beam comprises modulating the first beam and configure the second beam to generate the second control beam comprises frequency locking the second beam. In one embodiment, the QM-QFC system can attenuate the first signal by using an electro-optic modulator (EOM) to create a field envelope of the first laser beam. In one embodiment, frequency locking the second beam can include operating an Indium gallium arsenide (InGaAs) balanced amplified photodetector to obtain an Optical-Optical Double Resonance (OODR) spectrum, scanning the second beam while keeping the first signal frequency locked, generating an error signal by modulating the second beam at a predefined frequency, and operating a proportional-integral-derivative (PID) controller to lock the second beam according to the error signal.

Process 280 can proceed from blocks S2 and S6 to block S8. At block S8, the QM-QFC system can merge the signal photon at block S2 with the pump laser beams prepared at block S6, such as by merging the first signal with the at least one control beam. In one embodiment, the QM-QFC system can merge the first signal with the at least one control beam by resonantly coupling a first state of a diamond energy scheme to a third excited state of the diamond energy scheme. The diamond energy scheme can include the first state that is a ground state, a second state that is an excited state having higher energy than the first state, a third state higher that is an excited state having higher energy than the second state, a fourth state that is an excited state having higher energy than the third state, wherein an input quantum field that receives the first signal is connected by the first state and the third state of the diamond energy scheme and an output quantum field that outputs the second signal is connected by the second state and the fourth state of the diamond energy scheme, coupling the first state to the second state, coupling the third state to the fourth state of the diamond energy scheme.

Process 280 can proceed from block S8 to block S10. At block S10, the QM-QFC system can send the merged beam into room temperature vapor cell for conversion, such as sending the merged first signal with the at least one control beam into a quantum memory device for storage. In one embodiment, the quantum memory device can be a room temperature vapor cell. Process 280 can proceed from block S10 to block S12. At block S10, the QM-QFC system can filter out the control beam and original signal photon from the output to generate a second signal that encodes the qubit, and the second signal has a second frequency. In one embodiment, the QM-QFC system can filter out the at least one control beam by using a Glan laser (GL) polarizer and at least one wavelength filter.

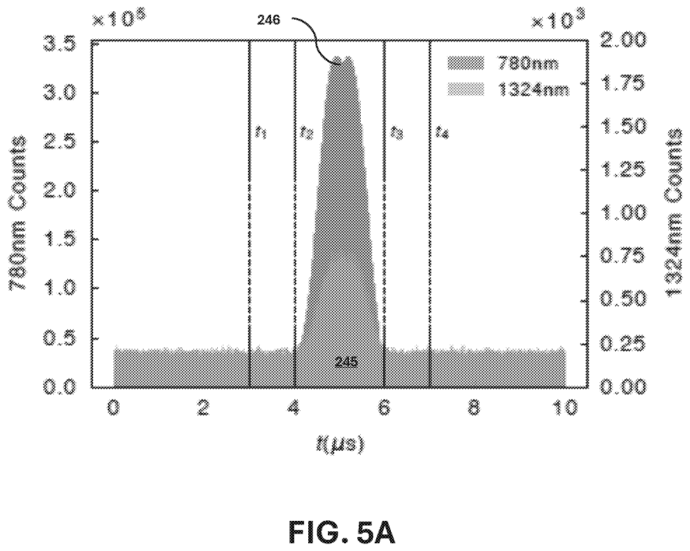

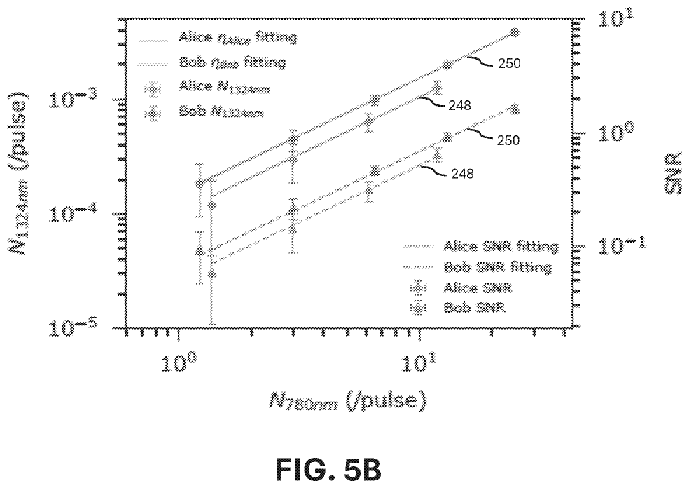

FIG. 5A depicts input and output pulses detected by the superconducting nanowire single-photon detectors (SNSPDs) used to estimate the efficiency of the QFC process. In the cycle time of 10 μs, t₁=3 μs, t₂=4 μs, t₃=6 μs and t₄=7 μs. Photon numbers are evaluated within [t₂, t₃] interval and the background noise photon rate is evaluated from [0 μs, t₁] and [t₄, 10 μs]. FIG. 5B depicts the measured number of photons of QFC pulses at 1324 nm (diamonds) and signal-to-noise ratio (SNR) at the detector (triangles) as a function of the mean photon number in the 780 nm input pulse for Alice 248 and Bob 250. The solid and dash lines are linear fittings to the conversion efficiency and SNR curves, respectively. The data are generated from calculating mean values after ~20 minutes of interrogation time for pulse repetition rates of 100 kHz. The error bars are dominated by detection and conversion efficiency errors.

The FWM QFC process can be driven with efficiencies higher than 50%. In an embodiment, a compromise is achieved by lowering the QFC efficiency and achieving an operational point with a good signal-to-noise ratio (SNR), which is the central figure of merit for HOM interference experiments. To measure the conversion efficiencies, there are used streams of ~0.9 μs FWHM pulses, with Alice's Pump I operating at 5.20 mW and Pump II at 2.95 mW, while Bob's Pump I is set to 0.45 mW and Pump II to 2.20 mW. The input pulses are detected using Superconducting Nanowire Single-Photon Detectors (SNSPD), and mean photon numbers for the probe and FWM QFC converted fields can be estimated using the resultant histograms as shown in FIG. 5A where 780 nm histogram is labeled 246 and 1324 nm histogram is labeled 245. The conversion efficiencies and signal-to-noise ratios are then characterized for different input photon levels. The conversion efficiencies for the two QM-QFCs (Alice and Bob) are measured to be (1.04±0.10)×10⁻⁴ and (1.52±0.05)×10⁻⁴, as shown in FIG. 5B.

### Measurement: Hong-Ou-Mandel Interference Stations

At the Charlie station in node 70 (e.g., second location) and Dave station in node 60 (e.g., at first location), active feedback compensates for polarization drifts caused by propagation in the optical fibers. Both 1324 nm pulse trains, \hat{b}_{A}(t) and \hat{b}_{B}(t), interfere at a 50:50 non-polarizing beamsplitter,

$${\hat{H}}_{N P B S} = - ( ℏ θ ) ( {b}_{A} {b}_{B}^{†} + {b}_{A}^{†} {b}_{B} ) .$$

The beamsplitter outputs, ĉ₁(t) and ĉ₂(t), are measured at the SNSPD, and the coincidence rate between both interferometer arms is computed.

### Quantum-Enabling Interface Plane Implementation

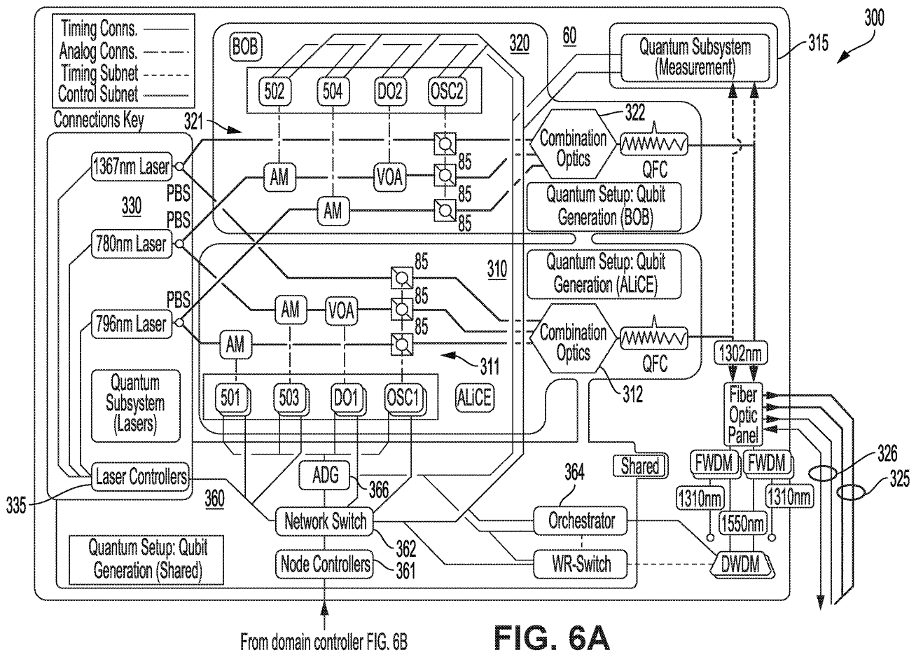

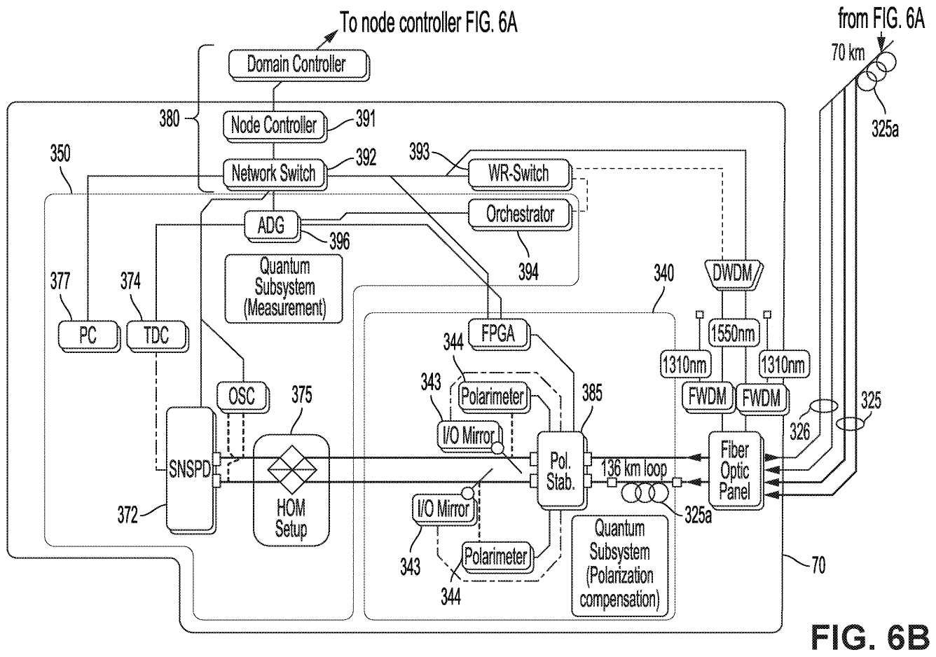

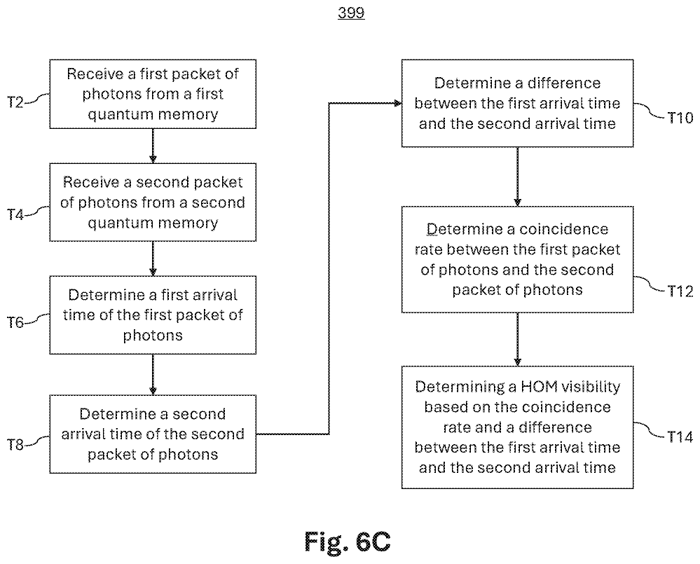

Referring back to FIG. 3, the QEIP 130 provides the functionality used for QN protocol execution using deployed fiber infrastructure. In view of FIGS. 6A and 6B, an embodiment of the QEIP 300 includes five key physical setups and subsystems: the Alice qubit generation setup at Alice node 310 and Bob qubit generation setup at Bob node 320, laser control subsystem 330, polarization compensation subsystem 340, and measurement subsystems 350. These systems configure and provide the temporal changes in the FWM Hamiltonian used to evaluate the HOM visibility of qubit interference at the end of the quantum channels.

The network clocking infrastructure, capable of sub-nanosecond-level synchronization resolution, and the polarization compensation subsystem, providing a scalable approach to making long-haul single-mode fibers compatible with QN operations are now described.

FIGS. 6A-6B depict the physical network nodes forming the QEI. At a node, e.g., node 60, there are two-qubit generation setups: a laser and measurement subsystem. At the other node 70, there is hosted a polarization compensation and measurement subsystem. The Alice and Bob qubit generation setup nodes 310, 320 share a control and timing infrastructure 360 including sharing of network and timing switches 362, node controller 361, orchestrator 364, multi-channel arbitrary delay generator 366. The laser subsystem 330 including the controllers 335, and 795 nm, 780 nm, 1367 nm lasers distribute laser light to Alice and Bob nodes. Each qubit generation setup hosts a rubidium quantum frequency-conversion system and auxiliary devices (e.g., signal generators, delay controller, variable optical attenuator, beam splitters, feedback oscilloscope, combiner) and is connected to a dedicated fiber 325 (e.g., single-mode long fiber) reaching the node 70. The local node 60 has a detection subsystem, e.g., referred to herein as Dave 315 that is identical in functionality to node 70's Charlie node detector subsystem 350. This configuration adds a 20 km loop in one of the detector input channels. The Charlie node at node 70 is configured to host the Hong-Ou-Mandel interference measurement setup 375. One path from node 60 is set up to be longer by approximately 18 km, going through node 70's (e.g., second site's) local fiber loop infrastructure for phase randomization between channels. The polarization compensation subsystem 340 compensates for polarization modification in the 70 km. Charlie's detection subsystem 350 hosts an SNSPD 372, time-to-digital converter 374, and a timing and control infrastructure 380.

### Controllable Quantum Network Nodes

With more particularity, in the embodiment depicted in FIGS. 6A-6B, there are four controllable nodes in the QEI network. Alice and Bob are light-matter interface nodes 310, 320 respectively, located on the Node 60 (e.g., first site). The two nodes share the same laser subsystem 330 including lasers at 795 nm, 780 nm, and 1367 nm wavelengths and associated locking systems. The shared lasers are split and sent to independent QM-QFC setups 311, 321 in Alice and Bob nodes respectively. Each QM-QFC setups have its independent acousto-optical modulators, electro-optic modulators and optical attenuators to carry out primitive operations.

The node 60 (e.g., first site) shares a network/timing switch 362, controller 361, sequence orchestrator 364, and multi-channel delay generator 366. The QM-QFC (Alice and Bob) nodes 310, 320 also share a laser subsystem, including lasers at 795 nm, 780 nm, and 1367 nm wavelengths, controlled by a dedicated computer. The QFC qubit creation procedure is executed via acousto-optical devices and variable optical attenuator (VOA) devices that modulate each laser. Feedback is used to optimize the signal-to-background of the amplitude modulation. The modulated laser signals are combined in an optical setup, e.g., combination optics 312, 322 at respective Alice and Bob nodes, and then sent to the QM-QFC systems (also see combination optics apparatus 230 in FIG. 4A). Their outputs are connected to dedicated fibers 325 that carry the quantum signals to the Node 70 (e.g., second site).

In FIG. 6B, an example implementation of a measurement node is shown. The measurement node shown in FIG. 6B can be at the Node 70 (e.g., second site) and at the Node 60 (e.g., first site). The measurement node can include at least a timing and control infrastructure 380, a polarization compensation system 340 and a HOM detection system 350, and various other components shown in FIG. 6B. Packets of photons encoding qubits in their quantum states can arrive through the optical paths (e.g., fibers), such as a 70 km path and a 88 km path, and are directed to HOM detection system 350 via polarization compensation system 340. Node controller 391 can be configured to control various aspects of the measurement node shown in FIG. 6B. node 70. Network switch 392 can be configured to route signals among the different components of the measurement node. A timing switch 393 can be configured to perform synchronization, such as synchronizing signals among the measurement node.

In one embodiment, two optical paths implemented by fibers 325, 326 can connect the Alice setup 310 and the Bob setup 320 to the measurement node. The two optical paths can have different distances. By way of example, fibers 325 can have a length greater than the length of fibers 326. In one embodiment, fibers 326 can have a length of 70 kilometers (km) and fibers 325 can have a length of 88 km as a result of having a fiber loop 325a of approximately 18 km. The fiber loop 325a can provide phase randomization between the two optical paths implemented by fibers 325, 326.

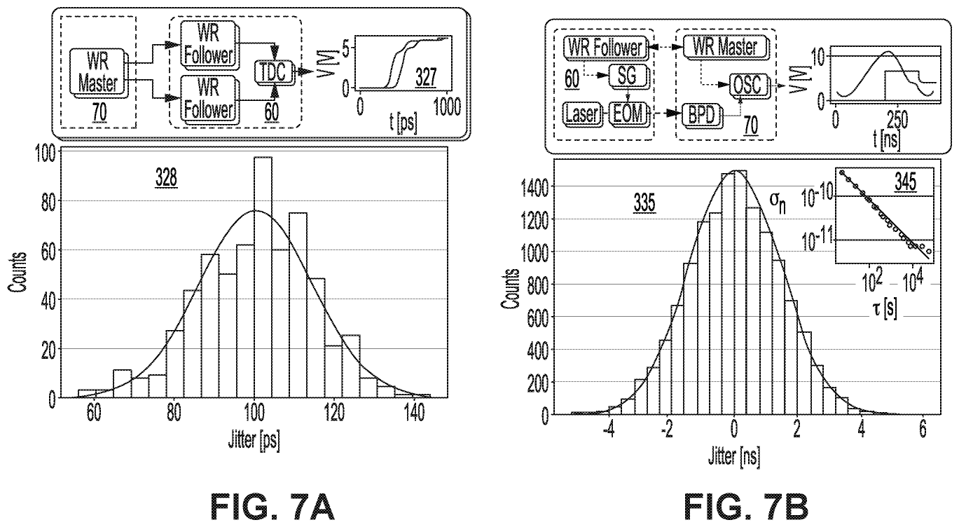

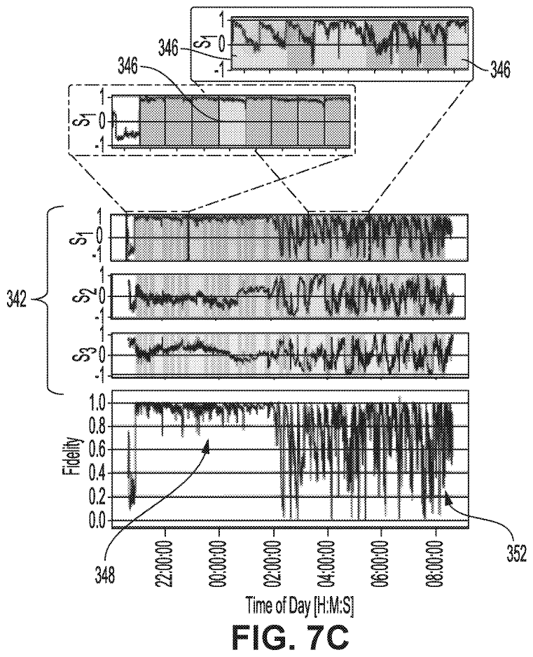

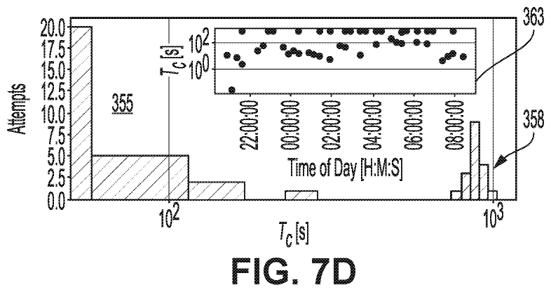

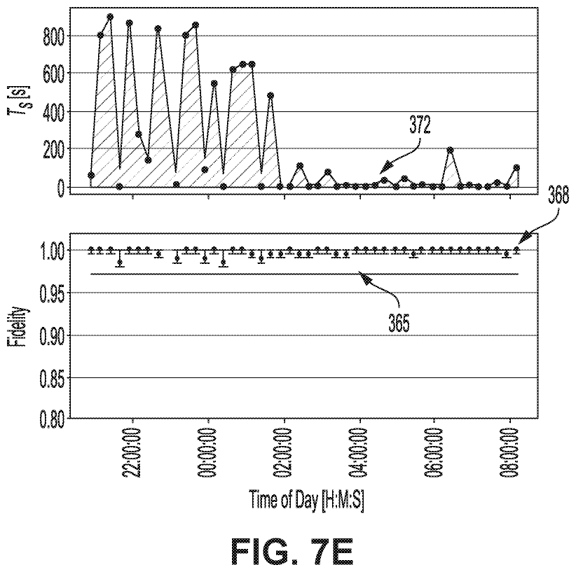

Polarization compensation system 340 can be configured to compensate a polarization of the packets of photons received from the optical paths. In polarization compensation system 340, the fiber loop 325 can be repeated to perform compensation that simulates the phase randomization between fibers 325, 326. By way of example, a polarization stabilization system 385 can use optical components 343 to direct macroscopic QFC states (e.g., in the form of macroscopic light) to polarimeters 344 for measurements during a stabilization phase. Optical components 343 can be, for example, computer-controlled mirrors or optical switches. Optical components 343 can be controlled by a computing device or an integrated circuit (IC), such as a field-programmable gate array (FPGA) in polarization compensation system 340. As shown in FIG. 6B, the optical components 343 can be controlled to direct the macroscopic QFC states either towards polarimeters 344 or towards HOM detection system 350. In one embodiment, the optical components can be automatically removed or switched, in response to completing the polarization compensation, to allow the macroscopic QFC states to be directed to HOM detection system 350. Additional details on polarization compensation can be found in further descriptions below, such as descriptions of FIG. 7C to FIG. 7E.

HOM detection system 350 can include various components for measuring the packets of photons and for determining an indistinguishability between the packets of photons received by the measurement node. HOM detection system 350 can include at least a HOM setup 375, a SNSPD 372, a sequence orchestrator 394, a delay generator 396, time-to-digital Converter (TDC) 374, and a PC 377. By way of example, the measurement node can receive a first packet of photons from a first quantum memory and a second packet of photons from a second quantum memory. The first memory and the second memory can be located at different setups. By way of example, the first memory can be a quantum memory in the Alice setup 310 and the second memory can be a quantum memory in the Bob setup 320. The first packet of photons and the second pack of photons can arrive at HOM detection system 350 at different arrival times. In one embodiment, the different arrival times can be a result of the different lengths of fibers 325, 326.

The first and second packets of photons can be received by the HOM setup 375. HOM setup 375 can include at least one beam splitter. HOM setup 375 can route the first and second packets of photons to SNSPD 372 via two local optical channels within HOM detection system 350. SNSPD 372 can determine arrival times of the first and second packets of photons. By way of example, SNSPD 372 can record photon detection events, such as arrival of photons at SNSPD 372 and their arrival times via the two local optical channels. SNSPD 372 can output the photon detection events and arrival times to TDC 374 and TDC 374 can convert the arrival times into digital data for PC 377. In one embodiment, SNSPD 372 can be connected to a classical network to allowing real-time status monitoring and data acquisition.

In one embodiment, PC 377 can determine a difference between the arrival times of the first and second packets of photons. PC 377 can further determine a coincidence rate between the first packet of photons and the second packet of photons. To determine the coincidence rate, PC 377 can determine the first arrival time of the first packet of photons within a predefined period of time and determine the second arrival time of the second packet of photons within the same predefined period of time. When the predefined period of time includes both the first arrival time and the second arrival time, or photon detection events of both the first and second packets of photons are detected within the predefined period of time, PC 377 can record a count of coincidence. PC 377 can continue to determine the count of coincidence, or a coincidence rate (e.g., an overlap of the first and second packets of photons), for different periods of time, e.g., periodically at the same time interval.

After reaching a predefined number of counts of coincidence, PC 377 can control delay generator 396 to add a delay to one or both of the optical channels that received the first and second packets of photons. The delay can be added to the optical channels between polarization stabilization system 385 and HOM setup 375, and/or can be added to the local optical channels between HOM setup 372 and SNSPD 372. PC 377 can repeat the determination of counts of coincidences (e.g., determine a second count of coincidences) between with the added delay. PC 377 can determine a relationship between the first number of counts of coincidence and the second number of counts of coincidence. Based on the determined relationship, PC 377 can determine a HOM visibility that indicates a degree of indistinguishability between the first packet of photons and the second packet of photons. Additional details on the comparison of arrival times within a predefined period of time can be found in further descriptions below, such as descriptions of FIG. 7A and FIG. 7B.

In one embodiment, PC 377 can control delay generator 396 to adjust, based on the determined relationship, the delay to minimize the coincidence rate. Minimizing the coincidence rate can maximizes the HOM visibility and the degree of indistinguishability between the first packet of photons and the second packet of photons. Further, a difference between a mean number of photons in the first packet of photons and a mean number of photons in the second packet of photons can be set to within a predefined threshold that maximizes the HOM visibility. In one embodiment, the mean number of photons in the first packet of photons and the mean number of photons in the second packet of photons can be defined or set within one pulse temporal envelope.

FIG. 6C depicts a flowchart of an example process 299 that can be performed by a measurement node according to an embodiment. Process 299 can include one or more operations, actions, or functions as illustrated by one or more of blocks T2, T4, T6, T8, T10 and/or T12. Although illustrated as discrete blocks, various blocks can be divided into additional blocks, combined into fewer blocks, eliminated, performed in different order, or performed in parallel, depending on the desired implementation.

Process 299 can be performed by a measurement node (e.g., measurement node 70 described herein) to determining a degree of indistinguishability among qubits and/or packets of photons (e.g., in the form of lasers). Process 299 can begin at block T2. At block T2, the measurement node can receive a first packet of photons from a first quantum memory. Process 299 can proceed from block T2 to block T4. At block T4, the measurement node can receive a second packet of photons from a second quantum memory. In one embodiment, the first packet of photons can be received from the first quantum memory via a first optical path having a first distance the second packet of photons can be received from the second quantum memory via a second optical path having a second distance different from the first distance. In one embodiment, the first packet of photons and the second packet of photons can be received by a HOM detection system and the HOM detection system, the first quantum memory and the second quantum memory are located in the same location. In one embodiment, the same location includes the first quantum memory, the second quantum memory and the HOM detection system is a first location. The first quantum memory can receive the first packet of photons from a first light source located in a second location different from the first location and the second quantum memory can receive the second packet of photons from a second light source located in a third location different from the first location and different from the second location.

Process 299 can proceed from block T4 to block T6. At block T6, the measurement node can determine a first arrival time of the first packet of photons. Process 299 can proceed from block T6 to block T8. At block T8, the measurement node can determine a second arrival time of the second packet of photons. Process 299 can proceed from block T8 to block T10. At block T10, the measurement node can determine a difference between the first arrival time and the second arrival time. Process 299 can proceed from block T10 to block T12. At block T12, the measurement node can determine a coincidence rate between the first packet of photons and the second packet of photons. Process 299 can proceed from block T10 to block T12. At block T12, the measurement node can determine a Hong-Ou-Mandel (HOM) visibility based on the coincidence rate and a difference between the first arrival time and the second arrival time. The HOM visibility can indicate the degree of indistinguishability between the first packet of photons and the second packet of photons.

In one embodiment, the measurement node can compensate a polarization of the first packet of photons and compensate a polarization of the second packet of photons. In one embodiment, the measurement node can compensate a polarization of the first packet of photons and a polarization of the second packet of photons using a plurality of optical components to direct macroscopic light to polarimeters for measurement, and automatically removing the plurality of optical components to release the first packet of photons and the second packet of photons to a HOM detection system.

In one embodiment, a difference between a mean number of photons in the first packet of photons and a mean number of photons in the second packet of photons can be within a predefined threshold that maximizes the HOM visibility. In one embodiment, the mean number of photons in the first packet of photons and the mean number of photons in the second packet of photons can be defined within one pulse temporal envelope.

In one embodiment, determination of the coincidence rate can include determining the first arrival time is within a period of time, determining the second arrival time is within the period of time, and in response to determining the first and second arrival times are within the period of time, recording a count of coincidence. In one embodiment, the first arrival time can be a photon detection event among a first set of photon detection events in a first channel that receives the first packet of photons, the second arrival time can be a photon detection event among a second set of photon detection events in a second channel that receives the second packet of photons, and the count of coincidence is among a number of counts of coincidence. In one embodiment, the number of counts of coincidence can be a first number of counts of coincidence. The measurement node can add a delay to at least one of the first channel and the second channel. The measurement node can further monitor, with the added delay, the first set of photon detection events in the first channel and the second set of photon detection events in the second channel. The measurement node can further determine a second number of counts of coincidence from the monitoring with the added delay. The measurement node can further determine a relationship between the first number of counts of coincidence and the second number of counts of coincidence.

In one embodiment, The measurement node can adjust, based on the relationship between the first number of counts of coincidence and the second number of counts of coincidence, the delay to minimize the coincidence rate, where minimizing the coincidence rate maximizes the HOM visibility and the degree of indistinguishability.

### Distributed Timing and Synchronization

The timing infrastructure within the QE interface plane ensures successful network operation, specifically for non-local or interference-based protocols, like HOM, where interference quality quantifies success. To ensure precise time synchronization across distantly located nodes, there is employed the White Rabbit bidirectional time-transfer technology along 70 km fiber links connecting quantum network nodes. Each node features a WR timing switch (e.g., timing switch 393 in FIG. 6B) delivering 10 MHz analog synchronized clock signals and phase-locked one pulse per second triggering signals.

To evaluate the performance of the timing system, the system measures the phase-locked pulses between the Alice and Bob nodes at node 60, synchronized to the WR source at Charlie in node 70. This setup yielded a network time jitter 327 of 100±14 picoseconds as shown in FIG. 7A. In particular, FIG. 7A shows a histogram of jitter events in the 70 km shared clock network, where Charlie (at node 70) is the master clock in a tree configuration connecting Alice and Bob (at node 60). Bob's time frame shows a jitter of 100±14 ps with respect to Alice's time frame. Inset: Three-node configuration of the White Rabbit devices and sample delay plot between both node 60 clocks where TDC is a Time Digital Converter element.

The effective network time jitter was additionally characterized by including the effect of protocol-relevant QEIP elements. Telecom laser pulses are generated at the node 60 using electro-optical modulators driven by signal generators, in which the local clock is phase-locked to the network timing system WR clock. After propagating over a 70 km fiber, the system compares the pulse arrival time at node 70 with a similarly clocked signal. FIG. 7B displays a histogram 335 of the timing differences between these pulses over twelve hours and in particular, a histogram of jitter events in the complete node 60-node 70 70 km QN fiber optic link after 12 hours of integration time. In an example, there was obtained a Gaussian distribution with an FWHM of 3.4 nanoseconds, three orders of magnitude smaller than the FWM-generated telecom photons' temporal width. Furthermore, the system estimates the Allan deviation σ_{η}(τ) associated with the long-distance jitter measurement as a function of varying interrogation times as shown in the inset 345 in FIG. 7B. It is observed that the Allan deviation following close a τ^{-1/2} trend, meaning that over intervals of less than twelve hours, the effective quantum network temporal jitter is stable and predictable. This level of time synchronization allows the control plane to accurately configure the QE interface plane to execute the HOM protocol sequences across the long distance, e.g., 158 km, network and provides a foundation for non-local QN operations.

With respect to the Allan Deviation of QN clock jitter, there is defined the normalized jitter as ηᵢ=1+f_{R}×tᵢ, where f_{R}=10 KHz is the pulsing repetition rate and tᵢ's are the jitter measurements. The Allan variance is defined according to the following equation S1 as:

$${σ}_{η}^{2} ( τ ) = \frac{1}{2 ( M - 1 )} {\sum }_{k = 1}^{M - 1} {( {y}_{k + 1} - {y}_{k} )}^{2} , \qquad ( S1 )$$

where

$${y}_{k} = ( 1 / L ) {\sum }_{i = 1}^{L} {η}_{( k - 1 ) L + i} , k = \{ 1 , 2 , … , M \} ,$$

L is the number of data points in each segment of interrogation time τ, L=τf_{R}, T=Mτ, and N=ML. T is 12 hours and N is the total number of collected data points.

### Polarization Compensation

Maintaining consistent polarization bases between nodes ensures photon indistinguishability; the polarization compensation procedure is an operation executed by the CP 120 and QEIP 130 interface planes in some embodiments. This procedure performs dynamic compensation of polarization drifts across the network to mitigate polarization fluctuations resulting from random birefringence induced by thermal changes, mechanical stress, fiber-core irregularities, and other changing environmental and material inhomogeneities. Before conducting HOM measurements using the QM-QFC generated quantum states, CW 1324 nm FWM-generated light is transmitted to characterize and compensate for polarization changes. This compensation is facilitated by a prototype device, which employs machine learning to modify the birefringence in compensation fiber loops at the terminals of the 70 km fibers linking node 60 and node 70. Feedback from polarimeters informs the compensation procedure. In some embodiments, an intermediary Field Programmable Gate Array (FPGA) allows the controller to monitor the compensation status and manage the schedule effectively.

By way of example, a complete polarization compensation system is characterized over 12 hours as proof of principle, with compensation applied every 15 minutes. The system measures polarization fluctuations by obtaining the Stokes vectors of the Four-Wave Mixing (FWM)-generated light during the free-running intermediate times and after executing the compensation procedure.

FIG. 7C depicts a plot showing the distributed polarization states between the nodes 60 and 70, with compensation executed every 15 minutes over an integration period of 12 hours. The PS is represented with the three normalized Stokes parameters (S₁, S₂, S₃) and a Fidelity F. The upper plots 342 show a close-up of a stable time segment 348 (around midnight hour) and a period 352 with more fluctuations (early morning hours). FIG. 7C further shows the correlation between the stability of the polarization and the time of day. The compensation is set to correct the initially horizontally polarized FWM-generated light, with initial Stokes parameters

$${S}_{1}^{0} = 1 ,$$

and

$${S}_{2}^{0} = {S}_{3}^{0} = 0 .$$

The fidelity of the corrected received signal is calculated as F= [symbol] |\hat{ρ}|H [symbol] =(1+S₁)/2, where S₁ is the first Stoke parameter. The fidelity reached after every compensation step is shown in FIG. 7E.

Additionally, there is evaluated the network downtime needed to perform the compensation. FIG. 7D depicts a histogram 355 showing the statistical distribution of the measured compensation times (e.g., every 15 minutes) over 12 hours, the cluster 358 near 10³ seconds represents the failed compensation attempts. Distribution of the time needed to stabilize the transmitted PS to desired state |H [symbol] . The inset 363 shows no correlation to the time of the day was observed during the 12-hour observation period.

Lastly, the system has determined the stability times, defined as the times when the fidelity has decreased to 0.97 after the compensation has been performed. There is chosen 0.97 as an example lower bound 365 by considering a long-distance HOM service scenario in which two symmetric channels of weak coherent pulses attain a HOM visibility of ~½f²≈0.47, where f is the fidelity of the channels with respect to each other. These measurements are shown in FIG. 7E which depicts the polarization fidelity measurements 368 with activated feedback every 15 minutes during a collection time of 12 hours. It is noticed that the fidelity routinely remains above the defined threshold 365 for more than 200 seconds during the high-stability periods of the long-distance fiber. Based on these results, it is chosen to activate the compensation protocol after every three-minute interval of free-drift time. This characterization allows to attain high HOM visibility during the entire duration of the quantum communication experiments while minimizing the downtime of the network, e.g., blocks 346 in FIG. 7C. FIG. 7E further shows the free-drift time 372 for which the polarization fidelity is preserved over 97% after the compensation is performed.

### Control Plane Implementation

Referring back to FIG. 3, the CP 120 generates commands distributed to all classical and quantum devices across the QEI network through the QEIP 130 and defines the primitive functions used to create QN protocols. The CP 120 addresses the following: (i) using QE-APIs to interface the CP 120 with the QAP 110 and QEIP 130, (ii) running physics-centric QN primitives associated with the temporal evolution of the quantum variables defining quantum network device performance, and (iii) running physics-centric QN protocols manipulating the Hamiltonian evolution of the quantum devices and measurements.

As an example of this concept, the system executes the HOM QN Protocol, an operation that must be performed to confirm the QN's readiness to establish an entanglement link. As QN protocols are realized through the interaction of the CP 120 and QEIP 130, implementing the HOM QN protocol begins by realizing the Southbound QE-APIs 133. Using the Virtual Instrument Software Architecture (VISA) protocol and custom device communication standards, there is developed QE-APIs including Python libraries to address and control network devices homogeneously, depending on functionality. These QE-APIs enable the development of the eight-step software procedure used by the control plane to orchestrate the QEI's operations for running the HOM protocol, e.g., shown in FIGS. 9A-9B. These primitives/operations run on the QEI to extract photo-counting measurements at the end node, from which high visibility HOM interference can be verified. These QN primitives include the modification of parameters of the frequency conversion FWM Hamiltonian,

$${π}_{Alice / Bob} = \{ {Ω}_{I} ( t ) , {Ω}_{II} ( t ) , 〈 {\hat{a}}_{A , B}^{†} ( t ) {\hat{a}}_{A , B} ( t ) 〉 \}$$

### (see Eq. (2)).

In some embodiments, the operation of each quantum node is controlled over the classical network using a set of application programming interfaces (APIs) to orchestrate the operations of various devices over the network infrastructure and enable quantum information flow. In some embodiments, quantum setups and subsystems are driven and monitored by devices (e,g, signal generators, configurable power supplies, oscilloscopes, time-to-digital converters, etc.) that can be connected to a classical network through standard Ethernet, USB, etc. interfaces. A series of APIs communicate with device drivers and lower-level software layers to control system elements over the network. In some embodiments, these drivers conform to the Virtual Instrument Software Architecture (VISA), an industry-standard API for communicating with instruments over Ethernet, GPIB, and USB interfaces. By way of example, APIs are developed to control devices on top of Python, using Python wrappers for VISA, such as PyVISA. For example, a Python package with all associated drivers and built-in search and identification protocols can be implemented. A characteristic of the APIs that control the devices is device agnosticism: they are designed such that higher-level quantum network control protocols do not depend on the make and model of individual devices.

In some embodiments, Quantum-Enabling (QE) Application Programming Interfaces (APIs) define how the control plane communicates with QE interface and application planes. Southbound QE-APIs includes drivers that handle communication between the controller and all devices and sub-system controllers on the QE interface plane. In some embodiments, these drivers can be Python-written and based on the Virtual Instrument Software Architecture (VISA) protocol and custom device communication standards. Depending on functionality, these libraries follow a facade design pattern to control network devices homogeneously. An example eight QE-protocol step procedure shown in FIGS. 9A-9B is built from these drivers.

Northbound QE-APIs are commands (e.g., Python commands) written on top of the example eight-protocol procedure. They can extract measurement and status information, including mean photon number, temporal photon shapes, and HOM visibility, along all procedure steps. In some embodiments, a technique disclosed herein also develops a dashboard/graphical user interface (GUI) to use the northbound QE-APIs to present relevant information as the QN protocol is executed.

### Execution of the HOM Protocol

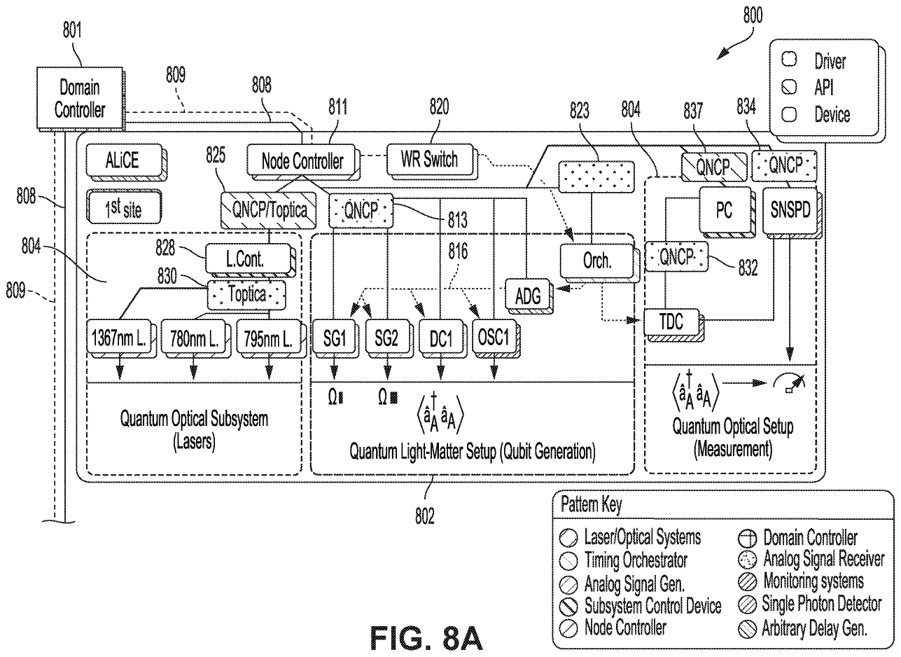

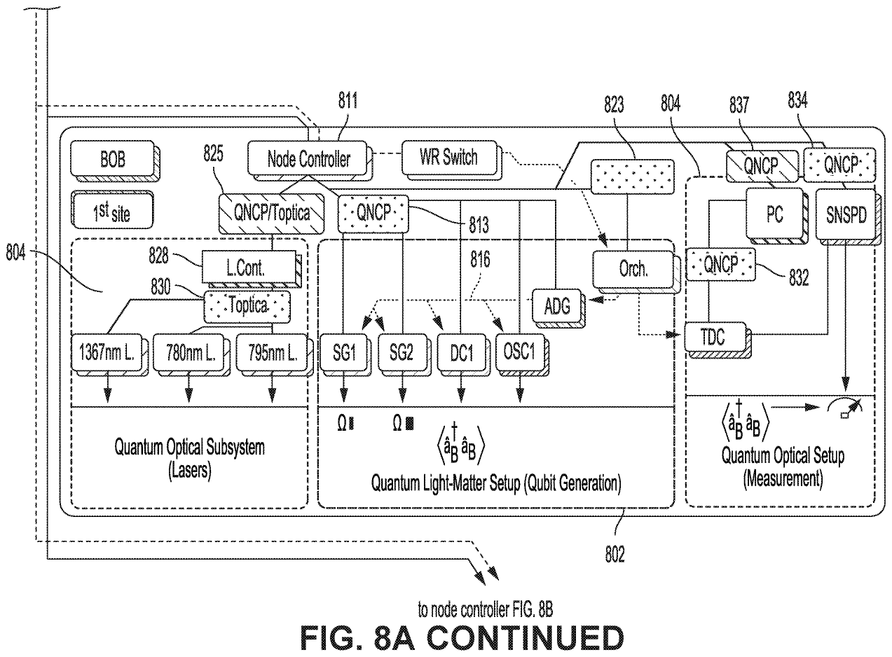

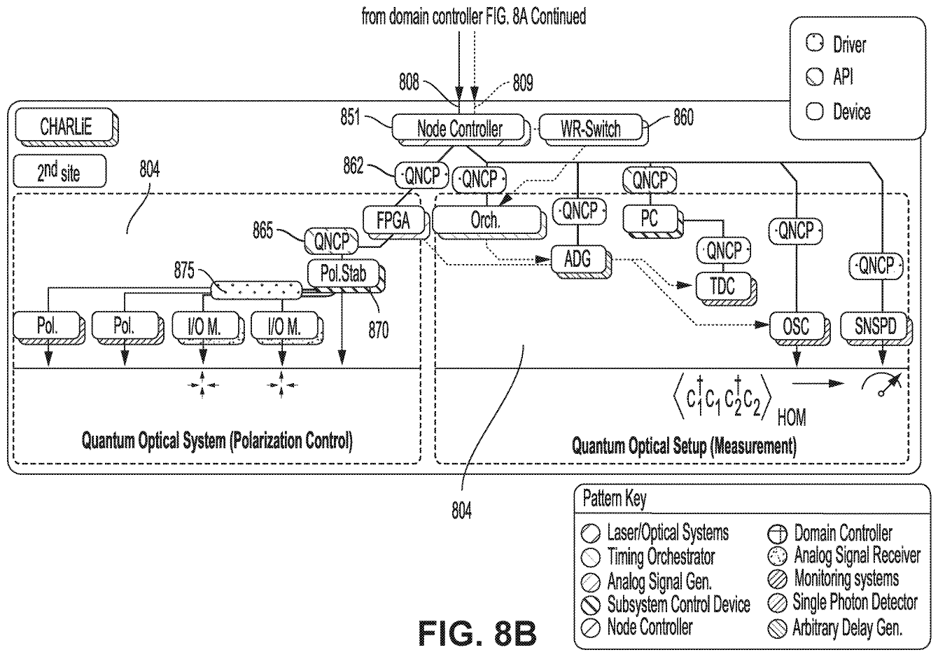

The execution of QN primitives and protocols highlights the coordination between the QDP 140, QEIP 130, and CP 120. This coordination, in the context of the full-network Hong-Ou-Mandel (HOM) visibility-check protocol, is presented in FIGS. 8A-8B. To perform the HOM indistinguishability protocol, the CP 120 coordinates and optimizes the function and interplay of the QN primitives, which is done using physics-relevant subsystems within the network via the QE-protocols. FIGS. 8A-8B, in some embodiments, present a streamlined view of the network hierarchy between three nodes and describes how the controller adjusts the active network between QE protocols, thereby facilitating the execution of the QN primitives forming the QN protocol. In FIGS. 8A-8B, following notations are used. SG: Signal Generator; L. Cont.: Laser Controller; L.: Laser; WR: White Rabbit; ADG: Arbitrary Delay Generator; OSC: Oscilloscope; Orch.: Orchestrator; TDC: Time-to-Digital Converter; SNSPD: Superconducting Nanowire Single Photon Detector; QNCP: Quantum Network Control Protocol; Pol.: Polarimeter; I/O M.: On/Off Mirror; Pol. Stab: Polarization Stabilizer; PC: Computer.

FIGS. 8A-8B particularly show the implementation of the QE interface plane 800: the node 70/node 60 QEI testbed has two identical co-located nodes at one location (e.g., node 60) and a third node at node 70 location. These FIGS. 8A-8B show the devices of each node (here depicted individually), coded by functionality, their connectivity, and their grouping in quantum optical system (quantum) setups (802) and quantum optical subsystems (804)

As shown in FIG. 8A, the QE interface plane 800 includes a domain controller 801 which is configured to establish communications with node controller 811 and the Alice and Bob nodes and directs the node controllers to initialize all systems they oversee, e.g., establish communications with all systems and subsystems of their node, turn lasers on, etc. As an example, the domain controller provides subnet control signals 808 and subnet timing signals 809 for orchestrating quantum operations across multiple nodes through their corresponding node controllers' northbound interface. Via control submet connections, the node controller 811 controls a set of application layer protocols which exploit the functionality of the hybrid quantum internet stack to orchestrate the operations of the various devices over the network infrastructure and enable quantum information flow. In an embodiment, the protocols can implement a Quantum Network Control Protocol (QNCP) set of drivers 813 which control signal generator devices, labeled SG1, SG2 which drive amplitude modulators (AMs) via acousto-optical devices used to generate respective pump fields 221, Ω_{I} and Ω_{II} further control delay controllers labeled DC1 which drives a variable optical attenuator (VOA). The QNCP set of drivers further control an oscilloscope device, labeled device OSC1, which provide monitored readings for use as feedback to optimize signals, e.g., amplitude modulation; and control the arbitrary delay generators, labeled ADG, to instruct the ADG to distribute triggers to the SGs via timing connections 816 used for the Qubit generation setup. A further driver 823 controls sequence orchestrator labeled Orch, which receive precise timing signals from the White-Rabbit timing switch 820 for orchestrating the QEI's operations for running the HOM protocol.

As further shown in FIG. 8A, further QNCP drivers 825 at each Alice and Bob node control the laser controller 828 which invoke further laser subsystem drivers 830 to control each 795 nm, 780 nm, 1367 nm lasers for the quantum optical subsystem.

As further shown in FIG. 8A, further QNCP drivers 832, 834 instruct the Time-to-Digital converter (TDC) and the Single Photon Detector, e.g., Superconducting Nanowire Single Photon Detector (SNSPD) respectively, to commence data collection at the quantum optical measurement subsystem at each Alice and Bob node. As shown, the SNSPD is connected to the TDC supervised by its dedicated PC via a QNCP API 837. The orchestrator governed by the WR-Switch 820 provides a timing connection to the TDC. Similarly, at the Charlie node at the second location, a node controller 852 receives similar timing and control subnet signals 808, 809 to perform similar actions at the quantum optical setup (measurement) 804 at the second location including the provision of timing controls at the White-Rabbit Switch device 860 clock. The Charlie node optical setup measurement sub-system 804 employs QNCP drivers (and APIs) governed by the primitives to control Orchestrator device and ADG, TDC, OSC and SNSPD devices in the manner as performed at the Alice and Bob node.

As further shown in FIG. 8B, at the Charlie node, the node controller 851 drives QNCP driver 862 to operate a field programmable gate array device (FPGA) of the polarization control (stabilization subsystem), e.g., to begin a polarization matching process. The FPGA invokes a QNCP API 865 to control polarization stabilizer 870. Polarization control subsystem further employs drivers 875 to control computer-controlled mirrors (I/O Mirrors) used to direct photons to polarimeters for measurements during the stabilization period.

The (HOM) visibility-check protocol begins by ensuring that a controller can communicate with network elements corresponding to the Hamiltonian parameters in the FWM systems: the Alice and Bob qubit generation (controlling the temporal evolution of the quantum variables

$${\hat{a}}_{in}^{†}$$

(t)âᵢₙ(t)) and

[symbol]

$${\hat{b}}_{i n}^{†}$$

(t)\hat{b}ᵢₙ(t) [symbol] ), the control-fields control (controlling the time evolution of the variables Ω_{I}(t) and Ω_{II}(t) in the FWM Hamiltonian for each QM-QFC), the polarization stabilization subsystem (guaranteeing the high fidelity preservation of the quantum variables b_{Alice} and b_{Bob} after long-distance propagation), and the HOM measurement subsystem (measuring the overlap between the quantum variables (â_{HOM}(t)|\hat{b}_{HOM}(t))) (see FIGS. 8A-8B). The interplay between the evolution of the QN primitives and the execution of the HOM QN protocol is detailed in FIGS. 9A-9B which depict the HOM protocol and highlighted network primitives executed by active QEIP components.

### Quantum Application Plane Implementation

A QN service is executed by physically running QN protocols, using the interaction of all the network planes via the QAP. Users or higher-order network processes initiate quantum services through an northbound interface (NBI), communicating requests to the CP. Based on the QN service requirements, the CP then issues a sequence of commands to the QEIP via an SB QE-API, enabling the physical realization of the QN service at the QDP.

### High-Visibility Hong-Ou-Mandel Quantum Network Service

An example of a robust QN service enabled by the QEIP components is the verification of high-visibility HOM interference over long distances using light-matter quantum interfaces. This capability can be basis for implementing more advanced QN protocols such as Cabrillo entanglement generation, Duan-Lukin-Cirac-Zoller entanglement creation, memory-assisted entanglement swapping, and quantum-repeater-assisted teleportation. Successfully executing high-visibility HOM interference at distant network nodes serves as a measure of the network's ability to distribute entanglement and perform teleportation, as demonstrated by the Peres Horodecki criterion and the CHSH bound (e.g., John Clauser, Michael Horne, Abner Shimony, and Richard Holt (CHSH) inequality). These criteria link HOM visibility directly to the quality of entanglement generation and delivery.

To benchmark the quality of a QN service, a framework is established that relates the network flow to the performance of a quantum measurement operation. For the particular case of the long-distance high-visibility HOM QN service, the system computes a second-order correlation between the outputs of the beamsplitter at Charlie or Dave and compare it to an analytic model to quantify the visibility of the interference effect. Taking pulse train and frequency lineshapes to be Gaussian, interference visibility can be evaluated in accordance with equation (2) as follows:

$$\frac{{dN}^{( 2 )}}{d Δ t} ∝ [ {\sum }_{n} G ( Δ t ; n Δ T , \sqrt{2} {σ}_{t} ) ] - 𝒱 G ( Δ t ; 0 , \frac{\sqrt{2} {σ}_{t}}{\sqrt{1 + {( 4 {πσ}_{v} {σ}_{t} )}^{2}}} ) cos ( δωΔ t ) \qquad ( 2 )$$

Where G(t; t₀, σ)=exp(−(t−t₀)²/2σ²), Δt is the temporal difference between events being correlated, ΔT is the pulse repetition period, σₜ and σₜ characterize the temporal pulse and light frequency of the incoming pulses, δω is the central frequency difference between inputs and V is the interference visibility.

It can be seen from Equation (2) the feature that HOM interference will deplete the pair rate within the “central” peak centered at Δt=0. The pulse modulation determines the linewidth when the pulses are much shorter than the CW coherence time. The central peak in the pairs' distribution is scaled down by a factor of (1−V). For the intermediate regime where the pulse width and CW coherence time are comparable, the central lobe of the distribution of the pairs can take on a two-peaked shape, as seen in the data below. By fitting the HOM experimental data and obtaining the figure of merit V, the HOM QN service is completed by verifying the high-visibility HOM interference over long distances.

### Long-Distance High-Visibility HOM QN Service

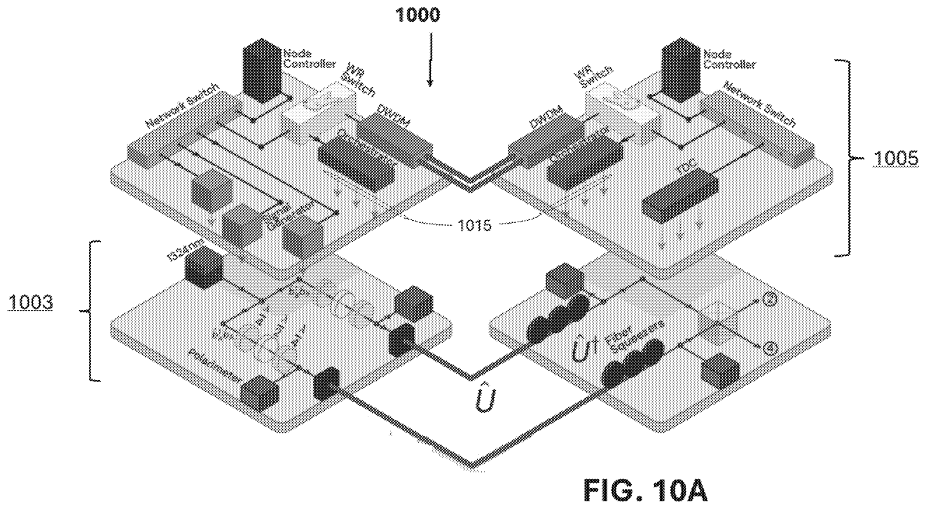

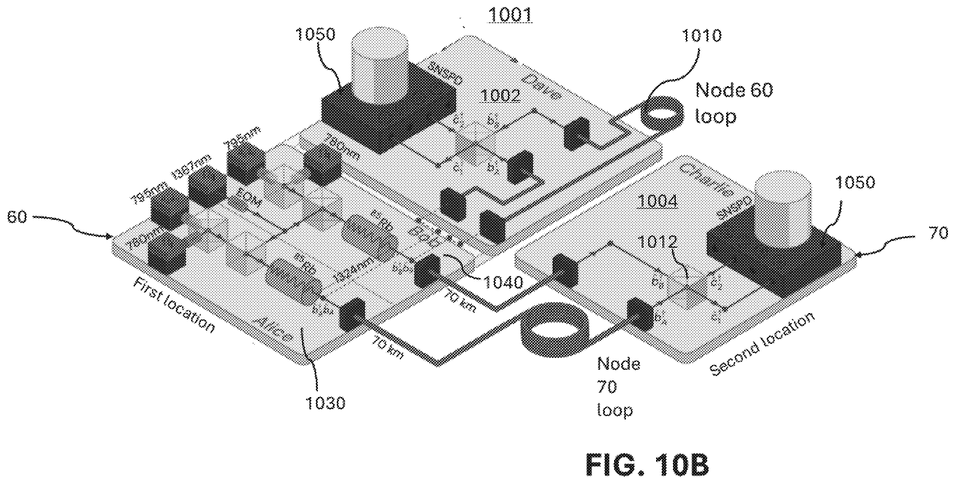

As shown in FIGS. 10A-10B, there is depicted an example HOM QN service that can be executed in the layered, e.g., 158 km, QEIP configuration. For characterization purposes, to start, there is used an experimental configuration, e.g., a QEIP testbed 1000, within the first site campus at a node 60, with an HOM measurement station at the Dave node 1002 at the first site. This configuration uses a fiber loop 1010 communicating a first local location in node 60 to a second local location in node 60 over a distance of 20 km (e.g., Loop 1010 in FIG. 10B), to perform the HOM visibility-check QN service.

With more particularity, there is a four-node QN established for use in the long-distance high-visibility HOM QN service. Two quantum memories and frequency conversion setups, i.e., Alice setup 1030 and Bob setup 1040, are co-located at the first site campus associated with node 60 and are connected independently to the network. Each one of Alice setup 1030 and Bob setup 1040 can include system 200 shown in FIG. 4A. The interference setups and telecom-compatible single photon nano-wire detectors (SNSPD) at Charlie station 1002 located at the second site node 70 and located at Dave station 1004 located at the first site campus at node 60. Each one of the Charlie station 1002 and Dave station 1004 can include the HOM detection system 350 shown in FIG. 6B. Optical fibers transport quantum information, e.g., at bottom layer configuration 1001, and quantum-enabling information, e.g., at middle layer configuration 1003. Other fibers transport classical timing triggers, network status, and sequencing information, e.g., at top layer 1005. The layering 1001, 1003, 1005 shown in FIGS. 10A-10B represents the coexistence of the three kinds of information needed for the function of the quantum network: classical, quantum-enabling, and quantum.

More particularly, in the stack-driven quantum memory QN, as shown in FIG. 10A, the top layer 1005 corresponds to a classical control network layer for user defined control and fast feedback. In top layer 1005, state-of-the-art networks make use of Software-Defined Networking (SDN) concepts to realize the management and control of long-distance information transfer and processing. These concepts are applied to the QEIP, where a network of digital devices manages and controls the quantum devices on-demand. Additionally, high-order management concepts are incorporated to distribute the photons created in the quantum memories across the network topology.

For example, this classical network portion of top layer 1005 of the QEIP, provides the classical information used for setting up a node for quantum communication and is configured to distribute the necessary control command sequences responsible for the execution of quantum network operations while also accommodating the traffic necessary for the monitoring and management of the multitude of interconnected devices encompassed in the quantum network. Embodied in node top layer 1005, the QE control plane employs the node controller and the network switch in a central role use their southbound interface (SBI) to drive devices of the quantum optical system setups (i.e., configurations of devices requiring direct command sequences from their node controller to operate, e.g., to initialize all systems they oversee, establish communications with all systems and subsystems at the node, turn on and control lasers, signal generators, etc.) and further interface with the quantum optical subsystems (e.g., those systems operated via an intermediate controller (computer/PC/FPGA) hosting the necessary control software and/or drivers. For example, this layer 1005 provides the classical timing triggers, network status, and sequencing information. Further, this layer provides the synchronization signals, e.g., synchronized clock signals and phase-locked triggering signals 1015 provided to the QE interface plane at layer 1003, are provided using the timing switch (WR-switch) and the Orchestrator, and the ADG. As further shown in FIG. 10A, Standard Dense Wavelength Division Multiplexing (DWDM) systems enable multiple independent communication channels, e.g., with two DWDM channels used for White Rabbit (WR) protocol connections, while others are used to interconnect the primary network switches in each node. Servers and network-compatible electronics are connected to each switch, enabling control operations of the QEIP testbed. In a larger-scale internet, multiple domains co-ordinate to perform quantum operations through orchestrating applications that communicate with the domain controllers through their NBI.

As further shown in FIG. 10A, the QEI layer 1003 includes devices supporting time, phase, and polarization analog measurements including generation and transmission of CW 1324 nm FWM-generated light that is transmitted to characterize and compensate for polarization changes. This layer 1003 particularly prepares long-distance connections to preserve quantum coherence with core functionality including: supporting time-sensitive operations as well as real-time compensation for environment-induced fluctuations in qubit transmission parameters. Long-distance synchronization systems are integrated with a temporal resolution below 100 ps, much lower than the temporal envelope of the photons traveling in the network (≤1 μs). Additionally, feedback mechanisms are implemented that preserve the polarization states traveling in the single-mode telecom fibers. In QEI layer 1003, quater wave (λ/4) and half wave (λ/2) elements, along with polarimeters, can manipulate the polarization states prior to the transmission and fiber squeezers can apply pressure to optical fibers in the revoicing node to function as a variable wave plate to manipulate the polarization state of light traveling through the optical fibers.

As shown in FIG. 10B, the Quantum network layer 1001 includes the interconnected quantum devices where quantum information can be communicated, buffered, and processed-including the quantum hardware necessary to generate entanglement using robust quantum interference. This quantum network layer 1001 includes room temperature quantum memories, qubit detection systems, and photonic quantum signals transmission. Use is made of absorptive atomic quantum memories that are compatible with a telecom infrastructure by showing coherent frequency conversion from photons with near-infrared frequency created in the quantum memories (780 nm/795 nm) to the telecom O-band 1324 nm. Further shown are the HOM detection setups 1050 at Dave and Charlie nodes, i.e., conducting HOM interference measurements.

In an embodiment, the three-layered optical network forming the QEIP testbed 1000 implements a hybrid network stack accommodating the quantum-enabling and quantum operations simultaneously. The components and functionality of the hybrid stack can be separated into three stack protocol sets associated with the role of each optical network described in FIGS. 10A-10B: 1) a quantum stack enabling the communication of quantum devices in order to perform the key operations necessary to achieve entanglement generation and distribution; 2) a quantum-enabling stack combines the stan-dard TCP/IP stack with time-sensitive principles to establish precise sequences that control quantum devices and compensation systems, allowing for high-fidelity transport of qubits; and 3) a classical stack is the standard TCP/IP, enabling the interconnection of classical devices controlling the QN. The control plane 120 of FIG. 3 includes protocols within the classical and quantum-enabling stacks required to control and orchestrate operations at the device, node, domain, and network levels.

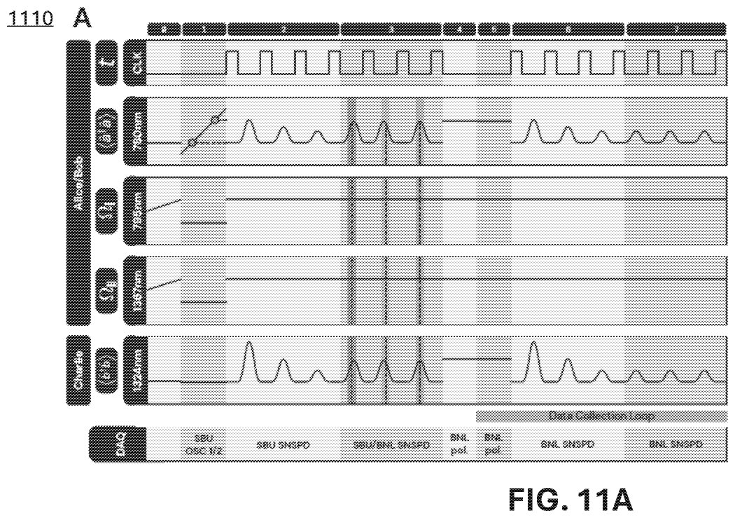

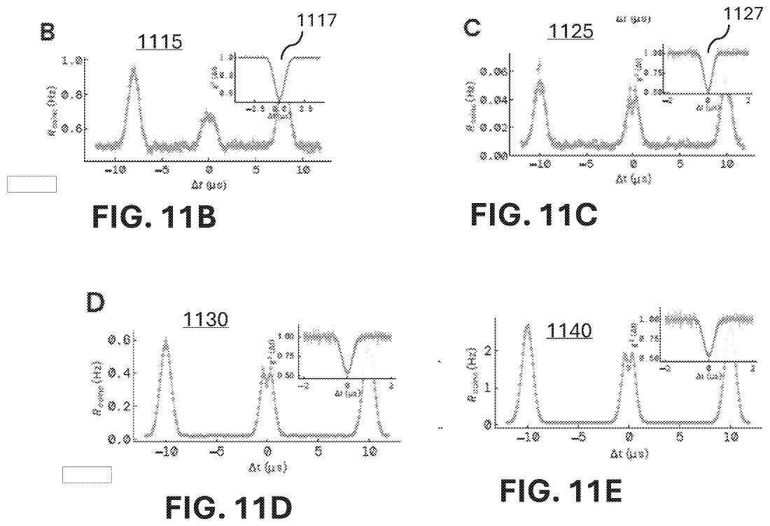

In performing the HOM visibility-check QN service, the experiments are driven using the QEI architecture to create independent quantum state sequences in each QM-QFC. The sequencing is controlled using the network primitives defined in FIGS. 9A-9B, in the following manner (see FIG. 11A for a complete sequence):
a) characterization of the 780 nm qubits modulation using the CP and QEIP to execute the Initialize Procedure( ) and Characterize_Optical_Modulators( ) QE protocols. As shown in FIG. 9A, the Initialize Procedure( ) QE protocol 902 runs method steps to: establish communication between the domain controller and the relevant setup and subsystem via southbound QE-APIs 133 (FIG. 3); turn on the lasers; have the domain controller set a pulse repetition rate according to service parameters; and set pump fields (Ω_{I}, Ω_{II}) equal. As shown in FIG. 9A, the Characterize_Optical_Modulators( ) QE protocol 904 runs method steps to: have the domain controller run a characterization and optimization sequence for optical modulators and attenuators at qubit generation setups through signal generation and acquisition (photodetector) devices. The associated primitives are <â^{†}â>_{A,B}(t).
b) application of QFC pumps to produce 1324 nm photon streams and verification of QM QFCs output mean photon numbers using the QDP, CP and QEIP to execute the Charaterize_Rates( ) QE protocol, characterizing the QN primitive associated to <â^{†}â>. This creates a pulse repetition rate of 125 kHz, and a temporal envelope σₜ=0.4 μs. As shown in FIG. 9A, the Charaterize_Rates( ) QE protocol 906 runs method steps to: have the domain controller begin pulsed operation of <â^{†}â>_{A,B}(t) at the qubit generation setups. The FWM output photon rates <\hat{b}^{†}\hat{b}>_{A,B}(t), at measurement subsystems at Charlie are characterized and coarsely balanced.
c) preparation of long-distance HOM data collection over thousands of production cycles using the QDP, CP, QEIP and QDP to execute Match_Timings( ) and Balance_Powers( ) QE protocols. This produces a mean photon rate of approximately 800 kHz for both Alice and Bob conversion channels at the HOM measurement beam splitter 1006 at the Dave station (e.g., at node 60), preparing the primitive associated to <\hat{b}^{†}\hat{b}>. As shown in FIG. 9A, the Match_Timings( ) QE protocol 908 runs method steps to: have the domain controller use the measurement subsystems to extract the temporal histograms of both FWM output arms, <\hat{b}^{†}\hat{b}>_{A,B}(t); and using the arbitrary delay generator 366 (FIG. 6A), the domain controller overlaps temporal envelopes of both channels. As shown in FIG. 9B, the Balance_Powers( ) QE protocol 914 runs method steps to return to pulsed operation, and using the temporal histograms, the FWM output photon rates <\hat{b}^{†\hat{b}>}_{A,B}(t), at measurement subsystems at Charlie are characterized and finely balanced.
d) verification of polarization preservation across the long-distance network using the CP an QEIP to run the Evaluate polarization( ) and Match_Polarizations( ) QE protocols. As shown in FIG. 9B, the Evaluate polarization( ) QE protocol 910 runs method steps to: have the domain controller return the network to continuous-wave operation at rates appropriate for polarimeter setups; and have the domain controller trigger the polarization compensation system to route the optical paths to the polarimeters and evaluate how often compensation should be scheduled. Further, as shown in FIG. 9B, the Match_Polarizations( ) QE protocol 912 runs similar method steps to have the domain controller return the network to continuous-wave operation at rates appropriate for polarimeter setups; and have the domain controller trigger the polarization compensation system to route the optical paths to the polarimeters and match the polarization of the paths.
e) quasi-real time long-distance HOM coincidence analysis using the QDP, CP, QEIP and QDP to execute Run_Experiment( ) QE protocol. This creates a mean number of photons at the input ports of the HOM BS is [symbol] n [symbol] ≈0.04/pulse for both Alice and Bob. As shown in FIG. 9B, the Run_Experiment( ) QE protocol 916 runs a method to have the controller engage the qubit generation setups to send pulses at the few photon level and the measurement subsystem to begin data acquisition from the Superconducting Nanowire Single-Photon Detectors (SNSPD) and TDC. The controller produces coincidence plots and calculates the interference quality—the visibility.

FIG. 11A is a plot 1100 depicting the orchestrated sequence for QM QFC generation and long-distance HOM interference. Plot 1100 shows the time dynamics of each node and their devices within the network.

FIG. 11B is a plot 1115 depicting the result of the HOM QN service at the Dave node 1002 and in particular the result of the 1324 FWM HOM pulsed quantum interference experiment operated for the 20 km QEI configuration at the node 60 site. The inset 1117 shows the result for a CW input (continuous-wave HOM) and the plot 1115 shows the pulsed results, exhibiting the main features predicted by the model. FIG. 11B also shows the fits of the experimental data to Eq. (2), from which a visibility of 47% can be determined, showing the robustness of the QN service over a distance of 20 km.

FIGS. 11C, 11D and 11E depict the 1324 FWM HOM pulsed quantum interference experiments operated for the long distance, e.g., 158 km, QEI configuration at the Node 60 (e.g., first site) and Node 70 (e.g., second site) locations. The measurements are done for different mean photon numbers at the exit of the frequency converters, as shown in the detailed data in TABLE 1. The errors are calculated as the standard deviation of twenty mean values. Each data set corresponds to collecting data for 3 minutes (18 million pulses sent).

### Stack-Controlled Long Distance, e.g., 158 km, High-Visibility HOM Service

The degree of indistinguishability of the telecom polarization qubits transduced in two independent QM-QFCs using HOM interference experiments, with one arm of the interferometer being 70 km and the second being 88 km, is now demonstrated.

FIG. 11C is a plot 1125 depicting the result of the HOM QN service over a long distance, e.g., 158 km, for a pulsed input with a mean number of photons at the output of each QM-QFC of [symbol] n [symbol] _{Alice}=55.5±2.8 and [symbol] n [symbol] _{Bob}=9.5±0.5 defined within one Gaussian pulse temporal envelope FWHM of ~0.9 μs. The total losses (QM-QFC output to SNSPD input) through both the long-distance setups are measured to be ~28.3 dB for one link and ~36.0 dB for the longer arm. After long-distance propagation, the system obtains an average photon number per pulse of [symbol] n [symbol] ≈0.014 for both Alice and Bob conversion channels at the HOM measurement beam splitter in node 70 (e.g., at Node 70 (second site)). The HOM coincidence rate is measured versus the arrival time of the photons in the two detectors. The coincidences within a temporal region of interest (ROI) are post-selected with a width of 93.4 ns (24 μs divided into 257 bins). It is observed that the desired modulation in the coincidence rate, exhibiting a minimum for the initial identical polarization and reaching a maximum corresponding to uncorrelated photons beyond the coherence time of the FWM process. FIG. 11C also shows the fits of the experimental data to Eq. (2). An interference HOM visibility is measured to be V=(47+4) % and an FWM spectral width of σ_{ω}=(2π)×(609±91) kHz. The errors are calculated as the 68% confidence intervals of the fitting curves. Before collecting pulsed HOM data, the system verified the HOM setup alignment as a CW HOM service.

FIG. 11C inset shows a plot 1127 depicting the result of the HOM QN service over a long distance, e.g., 158 km, for a CW input with mean photon rates of ~330 kHz for both Alice and Bob conversion channel at the HOM measurement beam splitter in Noe 70 (e.g., second site). The FIGS. 11C-11E also shows the fits of the experimental data, from which a HOM visibility of 48% and a bandwidth of σ_{ω}=(21)×453 kHz can be determined.

FIGS. 11D-11E are respective plots 1130, 1140 each depicting the results of the HOM QN service over a long distance, e.g., 158 km, for different input photon numbers per pulse at the output of the QM QFCs. The pulse repetition rate was 100 kHz for all three cases, and statistics analysis was carried out with one hour of integration time for each case. Polarization compensation was performed every three minutes. The main data obtained from these measurements are summarized in Table 1. From the data fits, the system obtains the characterization of the quality of the HOM QN service. The system obtains photon spectrum FWHM widths of 1.4±0.2 MHz, 1.07±0.06 MHz, and 1.21±0.06 MHz, with corresponding photon FWHM pulse widths of 0.92±0.01 μs, 0.889±0.004 μs, and 0.880±0.002 μs, probing the repeatability of the stack-driven HOM QN service. The system further measured HOM visibilities of (47±4) %, (43±1) %, and (47±1) %, showing that the good visibility of the service is preserved as we approach a true single photon level at the output of the QM-QFCs.

TABLE 1

| | HOM1 | HOM2 | HOM3 |
|---|---|---|---|
| | (FIG. 11C) | (FIG. 11D) | (FIG. 11E) |
| <n>_{Alice, SBU} | 55 ± 3 | 183 ± 9 | 387 ± 24 |
| <n>_{Bob, SBU} | 9.5 ± 0.5 | 31 ± 2 | 66 ± 4 |
| <n>_{BS}(×10⁻²) | 1.40 ± 0.07 | 4.6 b ± 0.2 | 9.8 ± 0.6 |
| V(%) | 47 ± 4 | 43 ± 1 | 47 ± 1 |
| R_{coinc}(Hz) | 0.033 | 0.34 | 1.48 |

As shown in Table 1, data from the three pulsed HOM services are displayed in FIG. 11. [symbol] n [symbol] _{Alice}, SBU and [symbol] n [symbol] _{Bob,SBU} are the estimated number of photons per pulse leaving the Node 60 (e.g., first site). [symbol] n [symbol] _{BS} is the number of photons per pulse of each quantum channel arriving at Node 70 (e.g., second site) HOM measurement NPBS input ports. V is the visibility from the fitting from Eq. (5). R_{coinc} is the coincidence rate at Δt=0 obtained from the fit. Errors are calculated as the standard deviation of the means of twenty data sets.

From these experimental measurements, the performance of the QEI can be evaluated, e.g., when applying the original Cabrillo scheme to generate quantum memory entanglement over long distances. The first figure of merit is the long-distance HOM visibility measured at the Charlie node for a single-photon-level output at the QM-QFC sites. This is estimated from the data presented in Table 1 to be approximately 47%. Assuming further reductions in the detector noise and that single-photons have the same fidelities as coherent states, it is expected that a single-photon HOM visibility of 94%, far surpassing the Peres Horodecki criterion of 33% limit for entanglement generation and also beyond the 71% CHSH bound to use matter-matter entanglement to perform Bell inequality violation experiments. The second figure of merit is the two-photon coincidence rate for single-photon-level inputs, which, from the data presented in Table I, can be estimated to have a lower bound of approx. 4×10⁻⁴s⁻¹ for the long-distance experiments. This estimation is competitive with the two-photon rate measured in state-of-the-art long-distance matter-matter entanglement experiments.

In view of the results, the QN architecture paradigm and QEI infrastructure can be extended to perform quantum memory entanglement experiments over unprecedented distances in deployed fibers. These extensions will include the QAP running the QN service of entanglement generation among the quantum memories, including following additions. First, at the QDP level, the QFC scheme is extendible to generate entanglement with photons directly at 1324 nm and the collective state of the QM. This can be done by correlating the polarization state of the created 1324 photon to that of the resultant intermediate magnetic atomic sublevels. Second, after the photon's propagation in the long-distance links at the CP level, there is performed a Bell-state projection QN service, regulating the creation of entanglement among the magnetic substates of the remote QMs. This measurement uses further additions to the QEIP, which includes having QE-APIs running unperturbed over several hundreds of hours and phase stabilization across the whole quantum network testbed, which can be achieved by monitoring the long-distance HOM interference service.

An additional improvement to the QDP can be to have long QM coherence times on the order of milliseconds, allowing for the long-distance transmission of the telecom photons and the Bell state result transmission across the quantum-enabling network. With these conditions, it is possible for the QAP to verify the entanglement created between the QMs by retrieving their state into an entangled photonic state and reconstructing its density matrix.

The present disclosure describes embodiment of the design, deployment, and implementation of a first instance of a QEI network connecting QM-QFC atomic ensembles over a long distance, e.g., 158 km, of deployed fiber. Using the novel QN design paradigm, there has been demonstrated a stack-driven ubiquitous QN service, delivering long-distance, robust HOM interference with high visibility. This QN paradigm design can be applied to demonstrate further scalable long-distance QN services in a current three-node QN infrastructure, including the transmission of polarization entanglement created by high repetition sources of entangled photons and the storage of telecom polarization entanglement using remotely located quantum memories capable of heralding the storage of entanglement using non-demolition measurements and quantum state tomography. Further advanced experiments will lay the foundation for a stack-driven, long-distance quantum repeater implementation.

### Theory of Quantum Frequency Conversion in Rubidium

In an embodiment, a quantum frequency conversion system uses hot rubidium vapor in a glass cell. The system is modeled with an atomic ensemble in a cavity and the system applies the input-output theory. In the end, the system goes to the bad cavity limit. The Hamiltonian of the system is described as Ĥ=Ĥ₀+Ĥ_{L}, with the unperturbed Hamiltonian defined according to equation S2

$${\hat{H}}_{0} = {\sum }_{i = 1}^{N} [ {ℏω}_{2} {σ}_{22}^{i} + {ℏω}_{3} {σ}_{33}^{i} + {ℏω}_{4} {σ}_{44}^{i} ] + {ℏω}_{a} {a}^{†} a + {ℏω}_{b} {b}^{†} b , \qquad ( S2 )$$

where i represents different atoms in the ensemble. The ground state of the atom is set as the zero energy point. Here σᵢᵢ=ii, a and b represent 780 nm mode and 1324 nm mode inside the cavity. The interaction term under dipole approximation takes the form according to S3) as follows:

$${\hat{H}}_{L} = {\sum }_{i}^{N} - {d}^{i} \cdot E = {\sum }_{i}^{N} - {qr}^{i} \cdot E \qquad ( S3 )$$

In the current four-level Hilbert space (See FIGS. 7A-7E),

$${d}^{i} = {d}_{12} {σ}_{12}^{i} + {d}_{13} {σ}_{13}^{i} + {d}_{24} {σ}_{24}^{i} + {d}_{34} {σ}_{34}^{i} + h . c . \qquad ( S4 )$$

where the phase of atomic states i are chosen so that the dipole matrix element is real. The pump fields are treated as classical fields, and the system quantizes the two weak fields such that:

E=E_{I}+E_{II}+Eₛ+Eₜ,with

$${E}_{I} = {\vec{ϵ}}_{I} ( \frac{{ε}_{I}}{2} ) {e}^{- i {ω}_{I}^{L} t + i {\vec{k}}_{I} \cdot \vec{r}} + c . c . \qquad ( S5 )$$

$${E}_{II} = {\vec{ϵ}}_{II} ( \frac{{ε}_{II}}{2} ) {e}^{- i {ω}_{II}^{L} t + i {\vec{k}}_{II} \cdot \vec{r}} + c . c .$$

$${E}_{s} = \vec{ϵ} {ε}_{s} \hat{a} {e}^{i {\vec{k}}_{s} \cdot \vec{r}} + h . c .$$

$${E}_{t} = {\vec{ϵ}}_{t} {ε}_{t} \hat{b} {e}^{i {\vec{k}}_{t} \cdot \vec{r}} + h . c .$$

where it has been assumed fields propagate in z direction and

$${ε}_{s} = {( \frac{{ℏω}_{s}}{2 {ϵ}_{0} V} )}^{1 / 2} \qquad ( S6 )$$

$${ε}_{t} = {( \frac{{ℏω}_{t}}{2 {ϵ}_{0} V} )}^{1 / 2} .$$

Under the rotating wave approximation, the following is obtained:

$${\sum }_{i}^{N} {d}^{i} \cdot E = {\sum }_{i}^{N} [ {d}_{12} \cdot {\vec{ϵ}}_{I} \frac{{ε}_{I}}{2} {σ}_{21}^{i} {e}^{- i {ω}_{I}^{L} t + i {\vec{k}}_{I} \cdot {\vec{r}}_{i}} + {d}_{13} \cdot {\vec{ϵ}}_{s} {ε}_{s} \hat{a} {σ}_{31}^{i} {e}^{i {\vec{k}}_{s} \cdot {\vec{r}}_{i}} + {d}_{24} \cdot {\vec{ϵ}}_{t} {ε}_{t} \hat{b} {σ}_{42}^{i} {e}^{i {\vec{k}}_{t} \cdot {\vec{r}}_{i}} + {d}_{34} \cdot {\vec{ϵ}}_{II} \frac{{ε}_{II}}{2} {σ}_{43}^{i} {e}^{- i {ω}_{II}^{L} t + i {\vec{k}}_{II} \cdot {\vec{r}}_{i}} + h . c . ] = - {\sum }_{i}^{N} [ ℏ \frac{{Ω}_{I}}{2} {σ}_{21}^{i} {e}^{- i {ω}_{I}^{L} t + i {\vec{k}}_{I} \cdot {\vec{r}}_{i}} + ℏ \frac{{Ω}_{II}}{2} {σ}_{43}^{i} {e}^{- i {ω}_{II}^{L} t + i {\vec{k}}_{II} \cdot {\vec{r}}_{i}} + ℏ {g}_{s} \hat{a} {σ}_{31}^{i} {e}^{i {\vec{k}}_{s} \cdot {\vec{r}}_{i}} + ℏ {g}_{t} \hat{b} {σ}_{42}^{i} {e}^{i {\vec{k}}_{t} \cdot {\vec{r}}_{i}} + h . c . ] , \qquad ( S7 )$$

so the full Hamiltonian is:

$$\hat{H} = {\sum }_{i = 1}^{N} [ {ℏω}_{2} {σ}_{22}^{i} + {ℏω}_{3} {σ}_{33}^{i} + {ℏω}_{4} {σ}_{44}^{i} + ( ℏ \frac{{Ω}_{I}}{2} {σ}_{21}^{i} {e}^{- i {ω}_{I}^{L} t + i {\vec{k}}_{I} \cdot {\vec{r}}_{i}} + ℏ \frac{{Ω}_{II}}{2} {σ}_{43}^{i} {e}^{- i {ω}_{II}^{L} t + i {\vec{k}}_{II} \cdot {\vec{r}}_{i}} + ℏ {g}_{s} \hat{a} {σ}_{31}^{i} {e}^{i {\vec{k}}_{s} \cdot {\vec{r}}_{i}} + ℏ {g}_{t} \hat{b} {σ}_{42}^{i} {e}^{i {\vec{k}}_{t} \cdot {\vec{r}}_{i}} + h . c . ) ] + {ℏω}_{a} {a}^{†} a + {ℏω}_{b} {b}^{†} b \qquad ( S8 )$$

The unitary transformation of individual atoms is defined as:

$${U}_{R}^{i} = {e}^{- i ( {ω}_{II} + {ω}_{s} ) t + i ( {\vec{k}}_{II} + {\vec{k}}_{s} ) \cdot {\vec{r}}_{i}} {σ}_{44}^{i} + {e}^{- i {ω}_{s} t + i {\vec{k}}_{s} \cdot {\vec{r}}_{i}} {σ}_{33}^{i} + {e}^{- i {ω}_{I} t + i {\vec{k}}_{I} \cdot {\vec{r}}_{i}} {σ}_{22}^{i} + {σ}_{11}^{i} , \qquad ( S9 )$$

from which a global unitary transformation is defined as:

$${U}_{R} = {U}_{R , atom}^{1} ⊗ {U}_{R , atom}^{2} … ⊗ {U}_{R , atom}^{N} ⊗ {e}^{- i ( {ω}_{s} {a}^{†} a + {ω}_{t} {b}^{†} b ) t} , \qquad ( S10 )$$

so a state ket transform as

$$\vert \tilde{a} 〉 = {U}_{R}^{†} \vert a 〉 .$$

Here ω_{I} and ω_{II} are the laser frequency of pump field I and II, while ωₛ and ωₜ are the frequency corresponding to input signal photon s and output telecom photon t. The Hamiltonian transforms as

$$\tilde{H} = {U}_{R}^{†} \hat{H} {U}_{R} + i ℏ ( {\partial }_{t} {U}_{R}^{†} {U}_{R} ) . \qquad ( S11 )$$

Thus, the full Hamiltonian in the rotating frame takes the form

$$\tilde{H} = {\sum }_{i = 1}^{N} [ {ℏΔ}_{2} {σ}_{22}^{i} + {ℏΔ}_{3} {σ}_{33}^{i} + ℏ ( {Δ}_{4} ) {σ}_{44}^{i} + ( ℏ \frac{{Ω}_{I}}{2} {σ}_{21}^{i} + ℏ \frac{{Ω}_{II}}{2} {σ}_{43}^{i} + ℏ {g}_{s} \hat{a} {σ}_{31}^{i} + ℏ {g}_{t} \hat{b} {σ}_{42}^{i} + h . c . ) ] + {ℏΔ}_{a} {a}^{†} a + {ℏΔ}_{b} {b}^{†} b , \qquad ( S12 )$$

where it is assumed energy conservation ω_{II}+ωₛ−ω_{I}−ωₜ=0 and phase match condition \vec{k}ₜ+\vec{k}_{I}−\hat{k}_{II}−\vec{k}ₛ=0. The detunings are defined as Δ₂=ω₂−ω₁, Δ₃=ω₃−ωₛ, Δ₄=ω₄−ω₁₁−ωₛ, Δₐ=ωₐ−ωₛ and Δ_{b}=ω_{b}−ωₜ.

There is introduced atomic collective excitation operators, defined as:

$${S}_{2}^{†} = \frac{1}{\sqrt{N}} {\sum }_{i}^{N} {σ}_{21}^{i} , \qquad ( S13 )$$

$${S}_{3}^{†} = \frac{1}{\sqrt{N}} {\sum }_{i}^{N} {σ}_{31}^{i} ,$$

$${S}_{4}^{†} = \frac{1}{\sqrt{N}} {\sum }_{i}^{N} {σ}_{41}^{i} .$$

It is assumed that the system is in a weak excitation region, and the atomic states are always in the symmetric collective excitation manifold. This is a reasonable assumption for atomic state 3 and 4, since input 780 nm are of few photon level. This is also a reasonable assumption for state 2 due to the decay channels from 2 to the other ground hyperfine states outside of the four-wave mixing loop. With this low excitation assumption, the Sᵢ operators approximately obey the bosonic annihilation and creation operator commutation relation. Within this symmetric manifold, this can be written as:

$${\sum }_{i}^{N} {σ}_{22}^{i} = {S}_{2}^{†} {S}_{2} {\sum }_{i}^{N} {σ}_{33}^{i} = {S}_{3}^{†} {S}_{3} {\sum }_{i}^{N} {σ}_{44}^{i} = {S}_{4}^{†} {S}_{4} {\sum }_{i}^{N} {σ}_{43}^{i} = {S}_{4}^{†} {S}_{3} {\sum }_{i}^{N} {σ}_{42}^{i} = {S}_{4}^{†} {S}_{2} . \qquad ( S14 )$$

The Hamiltonian is then

$$\tilde{H} = ℏ [ {Δ}_{2} {S}_{2}^{†} {S}_{2} + {Δ}_{3} {S}_{3}^{†} {S}_{3} + {Δ}_{4} {S}_{4}^{†} {S}_{4} + ( \frac{\sqrt{N} {Ω}_{I}}{2} {S}_{2}^{†} + \frac{{Ω}_{II}}{2} {S}_{4}^{†} {S}_{3} + \sqrt{N} {g}_{s} \hat{a} {S}_{3}^{†} + {g}_{t} \hat{b} {S}_{4}^{†} {S}_{2} + h . c . ) ] + {ℏΔ}_{a} {a}^{†} a + ℏ {Δ}_{b} {b}^{†} b \qquad ( S15 )$$

The Heisenberg-Langevin equation is:

$$\dot{a} = ( - \frac{{κ}_{a}}{2} - i {Δ}_{a} ) a - i \sqrt{N} {g}_{s} {S}_{3} - \sqrt{{κ}_{a}} {a}_{i n} ( t ) \dot{b} = ( - \frac{{κ}_{b}}{2} - i {Δ}_{b} ) b - i {g}_{t} {S}_{2}^{†} {S}_{4} - \sqrt{{κ}_{b}} {b}_{i n} ( t ) {\dot{S}}_{2} = ( - \frac{{Γ}_{2}}{2} - i {Δ}_{2} ) {S}_{2} - {ig}_{t} {b}^{†} {S}_{4} - i \sqrt{N} \frac{{Ω}_{I}}{2} {\dot{S}}_{3} = ( - \frac{{Γ}_{3}}{2} - i {Δ}_{3} ) {S}_{3} - i \sqrt{N} {g}_{s} a - i \frac{{Ω}_{II}}{2} {S}_{4} {\dot{S}}_{4} = ( - \frac{{Γ}_{4}}{2} - i {Δ}_{4} ) {S}_{4} - {ig}_{t} {bS}_{2} - i \frac{{Ω}_{II}}{2} {S}_{3} \qquad ( S16 )$$

where the input noise terms is set, i.e., S_{i,in}(t)=0. In an embodiment, the system sets pump II detuning Δ₂=0. It is then reasonable to find steady state by setting \dot{S}₂=0. Thus there is had:

$$( - \frac{{Γ}_{2}}{2} - i {Δ}_{2} ) {S}_{2} = {ig}_{t} {b}^{†} {S}_{4} + i \sqrt{N} \frac{{Ω}_{I}}{2} , \qquad ( S17 )$$

Dropping the small non linear term results in:

$${S}_{2} = \frac{i \sqrt{N} \frac{{Ω}_{I}}{2}}{- \frac{{Γ}_{2}}{2} - i {Δ}_{2}} = A . \qquad ( S18 )$$

Thus, all nonlinear terms can be eliminated by substituting S₂, such that the equation in matrix form is:

$$( \begin{matrix}\dot{a} \\ \dot{b} \\ {\dot{S}}_{3} \\ {\dot{S}}_{4}\end{matrix} ) = ( \begin{matrix}( - \frac{{κ}_{a}}{2} - i {Δ}_{a} ) & 0 & - i \sqrt{N} {g}_{s} & 0 \\ 0 & ( - \frac{{κ}_{b}}{2} - i {Δ}_{b} ) & 0 & - {ig}_{t} {A}^{†} \\ - i \sqrt{N} {g}_{s} & 0 & ( - \frac{{Γ}_{3}}{2} - i {Δ}_{3} ) & - i \frac{{Ω}_{II}}{2} \\ 0 & - {ig}_{t} A & - i \frac{{Ω}_{II}}{2} & ( - \frac{{Γ}_{4}}{2} - i {Δ}_{4} )\end{matrix} ) ( \begin{matrix}a \\ b \\ {S}_{3} \\ {S}_{4}\end{matrix} ) + ( \begin{matrix}- \sqrt{{κ}_{a}} {a}_{i n} \\ - \sqrt{{κ}_{b}} {b}_{i n} \\ 0 \\ 0\end{matrix} ) \qquad ( S19 )$$

Defining the Fourier transform of the operators in the rotating frame as:

$$a ( {ω}^{′} ) = \frac{1}{\sqrt{2 π}} {\int }_{- ∞}^{∞} dt a ( t ) {e}^{i {ω}^{′} ( t - {t}_{0} )} \qquad ( S20 )$$

thus in frequency space the above matrix equation becomes

$$( S21 )$$

$$( \begin{matrix}( i ω - \frac{{κ}_{a}}{2} - i {Δ}_{a} ) & 0 & i \sqrt{N} {g}_{s} & 0 \\ 0 & ( i ω - \frac{{κ}_{b}}{2} - i {Δ}_{b} ) & 0 & - {ig}_{t} {A}^{†} \\ - i \sqrt{N} {g}_{s} & 0 & ( i ω - \frac{{Γ}_{3}}{2} - i {Δ}_{3} ) & - i \frac{{Ω}_{II}}{2} \\ 0 & - {ig}_{t} A & - i \frac{{Ω}_{II}}{2} & ( i ω - \frac{{Γ}_{4}}{2} - i {Δ}_{4} )\end{matrix} ) ( \begin{matrix}a ( ω ) \\ b ( ω ) \\ {S}_{3} ( ω ) \\ {S}_{4} ( ω )\end{matrix} ) = ( \begin{matrix}\sqrt{{κ}_{a}} {a}_{i n} \\ \sqrt{{κ}_{b}} {b}_{i n} \\ 0 \\ 0\end{matrix} )$$

Solving the linear equation results in obtaining:

$$b ( ω ) = \frac{- ( - {ig}_{t} {A}^{†} ) ( - i \frac{{Ω}_{II}}{2} ) ( - i \sqrt{N} {g}_{s} ) \sqrt{{κ}_{a}}}{A ( ω ) - B ( ω ) - C ( ω ) - D ( ω ) + E ( ω )} {a}_{i n} ( ω ) , \qquad ( S22 )$$

where

$$A ( ω ) = ( i ω - \frac{{κ}_{a}}{2} - i {Δ}_{a} ) ( i ω - \frac{{κ}_{b}}{2} - i {Δ}_{b} ) ( i ω - \frac{{Γ}_{3}}{2} - i {Δ}_{3} ) ( i ω - \frac{{Γ}_{4}}{2} - i {Δ}_{4} ) , B ( ω ) = ( i ω - \frac{{κ}_{a}}{2} - i {Δ}_{a} ) ( i ω - \frac{{Γ}_{3}}{2} - i {Δ}_{3} ) ( - i {g}_{t} \frac{- i \sqrt{N} \frac{{Ω}_{I}}{2}}{- \frac{{Γ}_{2}}{2} + i {Δ}_{2}} ) ( - i {g}_{t} \frac{i \sqrt{N} \frac{{Ω}_{I}}{2}}{- \frac{{Γ}_{2}}{2} - i {Δ}_{2}} ) , \qquad ( S23 )$$

$$C ( ω ) = ( i ω - \frac{{κ}_{a}}{2} - i {Δ}_{a} ) ( i ω - \frac{{κ}_{b}}{2} - i {Δ}_{b} ) {( - i \frac{{Ω}_{II}}{2} )}^{2} ,$$

$$D ( ω ) = ( i ω - \frac{{κ}_{b}}{2} - i {Δ}_{b} ) ( i ω - \frac{{Γ}_{4}}{2} - i {Δ}_{4} ) {( - i \sqrt{N} {g}_{s} )}^{2} ,$$

$$E ( ω ) = ( - i {g}_{t} \frac{- i \sqrt{N} \frac{{Ω}_{I}}{2}}{- \frac{{Γ}_{2}}{2} + i {Δ}_{2}} ) ( - i {g}_{t} \frac{i \sqrt{N} \frac{{Ω}_{I}}{2}}{- \frac{{Γ}_{2}}{2} - i {Δ}_{2}} ) {( - i \sqrt{N} {g}_{s} )}^{2} .$$

In the input-output formalism, the input-output relation is

b(ω)=[bₒᵤₜ(ω)−bᵢₙ(ω)]/\sqrt{κ^{b}}. (24)

In the conversion system, only 780 nm is input as mode aᵢₙ(ω) such that bᵢₙ(ω)=0, and the input output relation becomes

$${b}_{out} ( ω ) = \frac{- ( - i {g}_{t} {A}^{†} ) ( - i \frac{{Ω}_{II}}{2} ) ( - i \sqrt{N} {g}_{s} ) \sqrt{{κ}_{a} {κ}_{b}}}{A ( ω ) - B ( ω ) - C ( ω ) - D ( ω ) + E ( ω )} {a}_{i n} ( ω ) . \qquad ( S25 )$$

Further defining

$$η ( ω ) = \frac{- ( - i {g}_{t} {A}^{†} ) ( - i \frac{{Ω}_{II}}{2} ) ( - i \sqrt{N} {g}_{s} ) \sqrt{{κ}_{a} {κ}_{b}}}{A ( ω ) - B ( ω ) - C ( ω ) - D ( ω ) + E ( ω )} , \qquad ( S26 )$$

such that

$${b}_{out}^{†} ( ω ) {b}_{out} ( ω ) = {\vert η ( ω ) \vert}^{2} {a}_{i n}^{†} ( ω ) {a}_{i n} ( ω ) . \qquad ( S27 )$$

the photon flux operator is calculated as

$${b}_{out}^{†}$$

(t), from which the mean photon flux of the output 1324 nm signal can be obtained. By definition:

$${b}_{out} ( t ) = \frac{i}{\sqrt{2 π}} {\int }_{- ∞}^{∞} d {ω}^{′} {b}_{1} ( {ω}^{′} ) {e}^{- i {ω}^{′} ( t - {t}_{1} )} , \qquad ( S28 )$$

where b₁(ω) is understand to be field operator b_{ω} outside the cavity at t=t₁ in the future time.

$${a}_{i n} ( t ) = \frac{i}{\sqrt{2 π}} {\int }_{- ∞}^{∞} d {ω}^{′} {a}_{0} ( {ω}^{′} ) {e}^{- i {ω}^{′} ( t - {t}_{0} )} , \qquad ( S29 )$$

where a₀(ω) is understand to be field operator α_{ω} outside the cavity at t=0. Comparing the definition and the operator Fourier transform, there is had

aᵢₙ(ω)=ia₀(ω)

bₒᵤₜ(ω)=ie^{iω(t}^{₁}^{-t}^{₀}⁾b₁(ω), (S30)
however, the annihilation and creation operator is used in normal order. As they always appear in conjugate pairs, so

$${a}_{in}^{†} ( ω ) {a}_{in} ( ω ) = {a}_{0}^{†} ( ω ) {a}_{0} ( ω ) \qquad ( S31 )$$

$${b}_{out}^{†} ( ω ) {b}_{out} ( ω ) = {b}_{1}^{†} ( ω ) {b}_{1} ( ω ) .$$

Also, by definition of the Fourier transform,

$${b}_{out} ( t ) = \frac{1}{\sqrt{2 π}} {\int }_{- ∞}^{∞} d {ω}^{′} {b}_{out} ( {ω}^{′} ) {e}^{- i {ω}^{′} ( t - {t}_{0} )} , \qquad ( S32 )$$

so this can be written as:

$$〈 {b}_{out}^{†} ( t ) {b}_{out} ( t ) 〉 = \frac{1}{2 π} {\int }_{- ∞}^{∞} {\int }_{- ∞}^{∞} d {ω}_{1} d {ω}_{2} {e}^{- i ( {ω}_{2} - {ω}_{1} ) ( t - {t}_{0} )} η * ( {ω}_{1} ) η ( {ω}_{2} ) 〈 {a}_{0}^{†} ( {ω}_{1} ) {a}_{0} ( {ω}_{2} ) 〉 \qquad ( S31 )$$

The LHS is exactly the mean photon flux at time t. To find out conversion efficiency, in one case it is noted that contribution of

$$〈 {a}_{0}^{†} ( {ω}_{1} ) {a}_{0} ( {ω}_{2} ) 〉$$

only comes from near center frequency ω₀, so the narrow-bandwidth approximation can be made that

$$〈 {b}_{out}^{†} ( t ) {b}_{out} ( t ) 〉 = η * ( {ω}_{0} ) η ( {ω}_{0} ) \frac{1}{2 π} {\int }_{- ∞}^{∞} {\int }_{- ∞}^{∞} d {ω}_{1} d {ω}_{2} {e}^{- i ( {ω}_{2} - {ω}_{1} ) ( t - {t}_{0} )} 〈 {a}_{0}^{†} ( {ω}_{1} ) {a}_{0} ( {ω}_{2} ) 〉 = {\vert η ( {ω}_{0} ) \vert}^{2} 〈 {a}_{in}^{†} ( t ) {a}_{in} ( t ) 〉 , \qquad ( S34 )$$

thus the conversion efficiency is |η(ω₀)|². In the weak excitation region, this conversion efficiency is independent of the input photon number. In one embodiment setup, Δ₂=Δ₃=Δ₄=0, and Δₐ=Δ_{b}=0. In the limit of free-space coupling, i.e. very broadband cavity (large κₐ and large κ_{b}), the conversion efficiency can be approximated as:

$${\vert η ( 0 ) \vert}^{2} \approx {\vert \frac{4 N {g}_{s} {g}_{t} {Ω}_{I} {Ω}_{II}}{{Γ}_{2} ( {Ω}_{II}^{2} + {Γ}_{3} {Γ}_{4} / 2 )} \vert}^{2} \frac{1}{{κ}_{a} {κ}_{b}} . \qquad ( S35 )$$

### HOM Interference Model

Referring back to FIGS. 10A-10B, where two independent coherent beams are incident on the input ports a and b of a standard (i.e., ideal 50:50, non-polarizing) beam splitter 1012; the system calculates the rate of coincidences observed at the two output ports c and d (e.g., port c being Charlie in FIG. 10B, and port d being Dave in FIG. 10B) as a function of two specific measurement times t_{c} and t_{d}. One goal is to calculate what the shape of this coincidence rate looks like versus the arrival time difference τ=t_{c}−t_{d}. In the case of CW beams this will show the HOM interference dip. Then there is considered the case of the beams being pulsed in time.

### Initial Beam States

In an embodiment, the incoming beams each come from a laser with a small but finite range in linewidth. Each individual mode k within the beam is then assumed to be in a coherent state αₖ, where:

âₖαₖ=ααₖ (S36)

In an finite quantization volume, a is denoted as corresponding to a single mode as α(vₖ)=αₖ. This definition can be further expanded to continuous frequency space by making quantization volume infinite and use the notation α(v). If a is assigned to describe the beam entering at port a, and a corresponding spectral function β(v) for the beam at port b, as in FIG. 10B, then complete incoming state can be written as:

Ψ_{a,b}={α}ₐ⊗{β}_{b} (S37)

### Intensity, Transforms and Coherence Time: Weiner-Khinchin Interlude

Following the general Glauber theory of photo-detection, the intensity in any beam for a field with state Ψ at any given time t can be written as:

$$I ( t ) ≡ \frac{dN}{dt} = \int \frac{dN}{dv dt} dv ∝ Ψ {\hat{ℰ}}^{( - )} ( t ) {\hat{ℰ}}^{( + )} ( t ) Ψ = {\vert {\hat{ℰ}}^{( + )} ( t ) Ψ \vert}^{2} \qquad ( S38 )$$

Here \hat{ε}⁽⁺⁾(t) is the positive-frequency electric field operator:

\hat{ε}⁽⁺⁾(t)∝Σₖâₖe^{+iv}^{ₖ}^{t2π}∝∫âᵥe^{+ivt2π}dv (S39)

Applying this to the beam with state Ψ={α}:

I(t)∝|Σₖα(vₖ)e^{+iv}^{ₖ}^{+2π}|²∝|∫α(v)e^{+ivt2πdv}|² (S40)

Then there is defined the Fourier transform of α(v), which is denoted as A(t):

A(t)= [symbol] ⁻¹[α(v)](t)=∫α(v)e^{+ivt}2πdv and so I(t)∝|A(t)|² (S41)
as is also shown in channel a of FIG. 10A-10B (e.g., Alice channel in FIG. 10B). Equation S41 is used to define a convention for an inverse Fourier transform, i.e., from frequency to time, with the forward transform then being

α(v)= [symbol] [A(t)](v)=∫A(t)e^{-ivt2π}dt (S42)
and so refer to the two as a Fourier transform pair, denoted

[symbol]

Using the notation for auto-correlation yields:

Autocorrelation[A(t)](Δt)=(A*A)(Δt)=∫A(t′+Δt)A*(t′)dt′ (S44)

### Pair Rates and Coincidence Distribution

In further view of FIGS. 10A-10B, the input beam at point a with the spectral function α(v), which has transform A(t), and the input beam at point b has spectral function β(v), and corresponding transform B(t) are now described. After writing the output state, the system calculates the rates for observing pairs at the outputs, and then consider both the case of CW beams and envelope-pulsed beams.

For a coherent state defined by |{α} [symbol] _{Input} at the input to a 50:50 symmetric beamsplitter the state of the two outputs is |{α/\sqrt{2}} [symbol] _{Out1}⊗|{α/\sqrt{2}} [symbol] _{Out2} It can be seen that this evolution conserves energy while both beams inherit the same phase relation between modes as in the original beam. With two input beams, the system can simply add their amplitudes at the two outputs, keeping in mind that one of them has to be phase-reversed (this is needed to conserve energy and so a general property of beam splitters). The states of the output beams at port locations c and d, and their transforms, are

$${{\vert Ψ 〉 = \vert \{ ( α + β ) / \sqrt{2} \} 〉}_{c} ⊗ \vert \{ ( α - β ) / \sqrt{2} \} 〉}_{d} \qquad ( S45 )$$

$$\frac{( A ( t ) + B ( t ) )}{\sqrt{2}} at c and \frac{( A ( t ) - B ( t ) )}{\sqrt{2}} at d \qquad ( S46 )$$

With this, the rate for two-photon observations at ports c and d, specifically at times t_{c} and t_{d}, can be written as:

$$\frac{{d}^{2} {N}^{( 2 )}}{{dt}_{c} {dt}_{d}} ∝ {\vert {\hat{ℰ}}^{{( + )}_{c}} ( {t}_{c} ) {\hat{ℰ}}^{{( + )}_{d}} ( {t}_{d} ) Ψ \vert}^{2} \qquad ( S47 )$$

Substituting Equations S39 and S45 into the above then yields

$$\frac{{d}^{2} {N}^{( 2 )}}{{dt}_{c} {dt}_{d}} ∝ \frac{1}{4} {\vert \int ( α ( {v}^{′} ) + β ( {v}^{′} ) ) {e}^{+ {iv}^{′} {t}_{c} 2 π} {dv}^{′} \int ( α ( {v}^{″} ) - β ( {v}^{″} ) ) {e}^{+ {iv}^{″} {t}_{d} 2 π} {dv}^{″} \vert}^{2} = \frac{1}{4} {\vert ( A ( {t}_{c} ) + B ( {t}_{c} ) ) ( A ( {t}_{d} ) - B ( {t}_{d} ) ) \vert}^{2} \qquad ( S48 )$$

Expanding Eq. S48 gives three types of terms:
Balanced, synchronous terms which contain only combinations of products A( ) A*( ) and/or B( ) B*( ) with both paired factors evaluated at the same time. These terms are immediately real and correspond to products of the beam intensities, see below;
Balanced, asynchronous terms containing A( ) A*( ) and B( ) B*( ) products which are evaluated at differing times. These terms are where the interference effects will stem from;
Unbalanced terms, where at least one factor of A or B is not balanced by its complex conjugate. These terms will have a very fast varying phase at all times and will vanish in any time integration such when carried out in Equation S51 below.

If the unbalanced terms are dropped, then Eq. S48 can be re-arranged to

$$\frac{{d}^{2} {N}^{( 2 )}}{{dt}_{c} {dt}_{d}} ∝ \frac{1}{4} [ {I}_{a} ( {t}_{c} ) {I}_{a} ( {t}_{d} ) + {I}_{b} ( {t}_{c} ) {I}_{b} ( {t}_{d} ) + {I}_{a} ( {t}_{c} ) {I}_{b} ( {t}_{d} ) + {I}_{b} ( {t}_{c} ) {I}_{a} ( {t}_{d} ) ] - \frac{1}{2} Re \{ A ( {t}_{c} ) B * ( {t}_{c} ) B ( {t}_{d} ) A * ( {t}_{d} ) \} \qquad ( S49 )$$

where the single-photon intensities in the two incoming beams are identified as Iₐ(t)=|A(t)|² and I_{b}(t)=|B(t)|².

For an experiment, the system integrates the number of observed pairs over time, binned on the time difference between the detections. Accordingly variables from [t_{c}, t_{d}] are changed to [t_{c}, Δt=t_{d}−t_{c}] and then integrate the pair rate over all t_{c}

$$\frac{{dN}^{( 2 )}}{d Δ t} = \int \frac{{d}^{2} {N}^{( 2 )}}{{dt}_{c} d Δ t} {dt}_{c} \qquad ( S50 )$$

$$∝ \frac{1}{4} \int [ {I}_{a} ( {t}_{c} ) {I}_{a} ( {t}_{c} + Δ t ) + {I}_{b} ( {t}_{c} ) {I}_{b} ( {t}_{c} + Δ t ) + {I}_{a} ( {t}_{c} ) {I}_{b} ( {t}_{c} + Δ t ) + {I}_{b} ( {t}_{c} ) {I}_{a} ( {t}_{c} + Δ t ) ] {dt}_{c} - \frac{1}{2} \int Re \{ A ( {t}_{c} ) B * ( {t}_{c} ) B ( {t}_{c} + Δt ) A * ( {t}_{c} + Δ t ) \} {dt}_{c} \qquad ( S51 )$$

It can be recognized that the integral of each of the product terms in Equation S51 as having the form of either an auto-correlation or cross-correlation. Exchanging the order of integration and the Re{ } operation then simplifies this to a compact form in terms of just two autocorrelations:

$$\frac{{dN}^{( 2 )}}{d Δ t} ∝ [ ( {I}_{a} ⋆ {I}_{a} ) ( Δ t ) + ( {I}_{b} ⋆ {I}_{b} ) ( Δ t ) + ( {I}_{a} ⋆ {I}_{b} ) ( Δ t ) + ( {I}_{b} ⋆ {I}_{a} ) ( Δ t ) ] - \frac{1}{2} Re \{ \int A ( {t}_{c} ) B * ( {t}_{c} ) B ( {t}_{c} + Δ t ) A * ( {t}_{c} + Δ t ) {dt}_{c} \} = \frac{1}{4} ( ( {I}_{a} + {I}_{b} ) ⋆ ( {I}_{a} + {I}_{b} ) ) ( Δ t ) - \frac{1}{2} Re \{ ( ( AB \text{*)} ⋆ ( AB \text{*)} ) ( Δ t ) \} \qquad ( S52 )$$

In the form of Equation S52: the first, combinatoric term follows just from the beams' power envelopes, but the second, interference term is not yet connected to measurable properties of the individual beams. To make further progress there needs to be specified more about those properties. The case for CW beams is described next, and then the more general case of envelope-pulsed beams follows.

### Interference Dip, CW Case

Starting with the CW case, it is assumed that the frequency spread of the beam is relatively small and their spectral distributions are smooth. In this case the intensities Iₐ, I_{b} will be constant and the only structure in the pair rate vs Δt will come from the interference term. The only physical parameters that define the two beams are their lineshapes: for a narrow-band beam the different frequency components will fall out of phase with one another, making the sum phase at any given time effectively random. Thus it is expect to see that the interference term can be expressed purely in terms of the two beam's spectral density functions, or lineshape functions, which is known to be |α(v)|² and |β(v)|².

First the interference term is re-cast using α and β instead of A and B. Concentrating on just the argument of the Re{ } operator in Equation S52, after a bit of prestidigitation it can be arrived at:

((A B*)*(A B*))(Δt)= [symbol] ⁻¹[|(α*β)(v)|²] (S53)

where

α(v)=|α(v)|e^{iφ}^{_{α}}^{(v)}and β(v)=|β(v)|e^{iφ}^{_{β}}^{(v)} (S54)

The core of Equation S53 can be re-written vis

(α+β)(v)|²=|∫α(v′)β*(v′+v)dv′|²=∫α(v′)β*(v′+v)dv′∫a*(v″)β(v″+v)dv″=∫∫|α(v′)||α(v″)||β(v′+v)||β(v″+v)|×expi(φ_{α}(v′)−φ_{α}(v″))×expi(φ_{β}(v′+v)−φ_{β}(v″+v))dv′dv″ (S55)

Since it is expected that the phase functions σ_{α}(v) and σ_{β}(v) vary very quickly, and almost randomly, as a function of v; basically, changing v by an amount on the order of the inverse of the quantization time will bring a new and unrelated value to the phase. From this, then, it can be seen that the integral of Equation S55 will have approximately no contribution due to the rapidly and randomly shifting complex phases, except along the line where v′=v″ and the phase differences vanish and the integrand is entirely real. This then enables one to effectively replace the phase exponential factor with a delta function between v′ and v″

(α+β)(v)|²=∫∫|α(v′)||α(v″)||β(v′+v)||β(v″+v)|δ(v′−v″)dv′dv″=∫|a(v)||α(v′)||β(v′+v)||β(v′+v)|dv′=∫|α(v)|²|β(v′+v)|²dv′=(|α|²+|β|²)(v) (S56)

With this in hand, then, Equation S56 can be substituted into Eq. S53 and then into Eq. S52 to finally arrive at the pair rate versus time difference as:

$$\frac{{dN}^{( 2 )}}{d Δ t} ∝ \frac{1}{4} ( ( {I}_{a} + {I}_{b} ) ⋆ ( {I}_{a} + {I}_{b} ) ) ( Δ t ) - \frac{1}{2} Re \{ {ℱ}^{- 1} [ ( {\vert α \vert}^{2} ⋆ {\vert β \vert}^{2} ) ( v ) ] ( Δ t ) \} \qquad ( S57 )$$

### Gaussian Beam Lineshapes.

The following notation is used:

G(t;t₀,σₜ)=e^{-(t-t}^{₀}⁾^{²}^{/2σ}^{ₜ}^{²}

g(v;v₀,σᵥ)=e^{-(v-v}^{₀}⁾^{²}^{/2σ}^{ᵥ}^{²} (S58)

Here the convention of using upper-case variables for functions of time and lower-case for functions of frequency is continued. Note that the functions defined in Equation S58 are not area-normalized, but rather fixed to have a maximum value of 1 at t=t₀ and v=v₀.

First for the Cross-Correlation there is had:

$$G ( t ; {t}_{1} , {σ}_{t , 1} ) ⋆ G ( t ; {t}_{2} , {σ}_{t , 2} ) = \frac{\sqrt{2 π}}{( 1 / {σ}_{t , 1} ) ⊕ ( 1 / {σ}_{t , 2} )} G ( t ; {t}_{1} - {t}_{2} , {σ}_{t , 1} ⊕ {σ}_{t , 2} ) \qquad ( S59 )$$

$$G ( v ; {v}_{1} , {σ}_{v , 1} ) ⋆ g ( v ; {v}_{2} , {σ}_{v , 2} ) = \frac{\sqrt{2 π}}{( 1 / {σ}_{v , 1} ) ⊕ ( 1 / {σ}_{v , 2} )} g ( v ; {v}_{1} - {v}_{2} , {σ}_{v , 1} ⊕ {σ}_{v , 2} )$$

where the standard notation “⊕” is used for the quadrature sum x⊕y=\sqrt{x²+y²}. Using this convention for the transforms between time t and frequency v as laid out in Equations S41 and S42 there is then had:

[symbol]

⁻¹[g(v;v₀,σᵥ)](t)=σᵥ\sqrt{2π}G(t;0,1/2πσᵥ)e^{+iv}^{₀}^{t2π}

[symbol]

[G(t;t₀,σₜ)](v)=σₜ\sqrt{2π}g(v;0,1/2πσₜ)e^{-ivt}^{₀}^{2π} (S60)
where σₜ σᵥ=1/2π.

For the CW case, Iₐ(t) and I_{b}(t) are constant, and so the auto-correlation in the first term of Equation S57 reduces to a product, leaving:

$$\frac{{dN}^{( 2 )}}{d Δ t} ∝ \frac{1}{4} {( {I}_{a} + {I}_{b} )}^{2} - \frac{1}{2} Re \{ {ℱ}^{- 1} [ ( {\vert α \vert}^{2} ⋆ {\vert β \vert}^{2} ) ( v ) ] ( Δ t ) \} \qquad ( S61 )$$

Assuming two beams have identical linewidths σᵥ=σ_{v,1}=σ_{v,2}, but might have slightly different central frequencies v₂=v₀ and v₁=v₀+δᵥ. Then the intensity profiles for the beams at a and b can be written as:

$${\vert α \vert}^{2} ( v ) = \frac{{I}_{a}}{{σ}_{v} \sqrt{2 π}} g ( v ; {v}_{0} + δ v , {σ}_{v} ) \qquad ( S62 )$$

$$and$$

$${\vert β \vert}^{2} ( v ) = \frac{{I}_{b}}{{σ}_{v} \sqrt{2 π}} g ( v ; {v}_{0} , {σ}_{v} )$$

Substituting these into Equation S61 yields:

$$( S63 )$$

$$\frac{{dN}^{( 2 )}}{d Δ t} ∝ \frac{1}{4} {( {I}_{a} + {I}_{b} )}^{2} - \frac{1}{2} {I}_{a} {I}_{b} G ( Δ t ; 0 , 1 / ( \sqrt{2} 2 π {σ}_{v} ) ) cos ( 2 π δ v Δ t )$$

for the pair rate versus At. The form can be recovered in terms of a visibility V if the rate is normalized to the plateau at large At, arriving at:

$$\frac{{dN}^{( 2 )}}{d Δ t} ∝ 1 - 𝒱 G ( Δ t ; 0 , 1 / ( \sqrt{2} 2 π {σ}_{v} ) ) cos ( 2 π δ v Δ t ) \qquad ( S64 )$$

$$with$$

$$𝒱 ≡ \frac{2 {I}_{a} {I}_{b}}{{( {I}_{a} + {I}_{b} )}^{2}} .$$

### Pulsed Beam Case

The pulsed beam is modeled by taking the electric field function for a CW beam and modulating it with a pulse profile function.

Two “parent” CW beams are first represented with the electric field functions X(t) and Y(t), having the same properties as the A and B used in the general CW case, and particularly as described in Equation S54. Continuing the convention of using upper case for functions of time and corresponding lower case for functions of frequency

$${X ( t )}^{ℱ𝒯} ↔ x ( v ) \qquad ( S65 )$$

$$and$$

$${Y ( t )}^{ℱ𝒯} ↔ y ( v )$$

and then

x(v)=|x(v)|e^{iφ}^{ₓ}^{(v)}and y(v)=|y(v)|e^{iφ}^{_{y}}^{(v)} (S66)
with φₓ(v) and φ_{y}(v) being fast-varying, relatively random functions of v.

Now defining two pulse envelope amplitude functions P(t) and Q(t) for the two beams, making the full electric field functions at the two inputs:

A(t)=X(t)P(t)B(t)=Y(t)Q(t) (S67)

Iₐ(t)=|X(t)P(t)|²I_{b}(t)=|Y(t)Q(t)|² (S68)

Note that, even for given CW beams X and Y, the pulse envelope functions P and Q which will produce a given Iₐ and I_{b} as in Equation S68 are not unique, but could have an arbitrary phase structure over t. It is assumed that P and Q have constant phase; and so without loss of generality they can be taken as both being real and positive in the range 0≤{P(t), Q(t)}≤1 everywhere, in keeping with the beam splitter model. With this in hand and starting from Equation S53 there is arrived:

((AB*)*(AB*))(Δt)=(((XP)(YQ)*)*((XP)(YQ)*))(Δt)=(((XY*)(PQ)*)*((XY*)(PQ)*))(Δt)= [symbol] ⁻¹[|(F[XY*]* [symbol] [PQ])(v)|²]= [symbol] ⁻¹[|((x*y)* [symbol] [PQ])(v)|²] (S69)

Equation S69 is so far fully general. But use is made of the properties of x(v) and y(v), and the (x*y) (v) cross-correlation, as having random phases over v, since they are narrow-band CW beams. Following the logic leading from Eq. S55 to Eq. S56, now based on Eq. S66, Equation S69 can be simplified in two steps to:

(A B*)*(A B*)(Δt)= [symbol] ⁻¹[(x+y)* [symbol] [PQ])(v)|²]= [symbol] ⁻¹[((|x*y|²)*| [symbol] [PQ]|²)(v)]= [symbol] ⁻¹[(|x|²*|y|²)*| [symbol] [PQ]|²)(v)] (S70)

Substituting back into the master Equation S52 for the pairs rate results in:

$$( S71 )$$

$$\frac{{dN}^{( 2 )}}{d Δ t} ∝ \frac{1}{4} ( ( {I}_{a} + {I}_{b} ) ⋆ ( {I}_{a} + {I}_{b} ) ) ( Δ t ) - \frac{1}{2} Re \{ {\text{?}}^{- 1} [ ( ( {\vert x ( v ) \vert}^{2} ⋆ {\vert y ( v ) \vert}^{2} ) ⋆ {\vert \text{?} [ PQ ] \vert}^{2} ) ( v ) ] ( Δ t ) \}$$

as the generalized version of Equation S57, now for pulsed beams. Equation S71 is now completely actionable, involving only three well-defined, real-valued functions: the two parent CW beams' spectral line shapes |x(v)|² and |y(v)|² and the product (PQ)(t) of the two pulse envelope amplitude functions.

### Single, Synchronous, Symmetric Pulses

Looking first at the single envelop case, namely where (i) the beam envelopes contain only one well-shaped pulse each; (ii) the pulses both arrive at the beam splitter simultaneously; and (iii) the shapes of the pulses are symmetric around their peaks; this lets us conveniently set t=0 as the peak arrival time for both P (t) and Q (t). In this case the product transform F[PQ] (v) will be real and symmetric around v=0, and the cross-correlations will be easy.

It is also assumed the parent beam lineshapes and the pulse amplitude shapes are all Gaussians. For further simplicity the parent beams are assigned to have power levels

$${I}_{a}^{Max}$$

and

$${I}_{b}^{Max}$$

and assume P(0)=Q(0)=1 at the pulse peak. Then, following on Equation S62 there is set

$${\vert x \vert}^{2} ( v ) = \frac{{I}_{a}^{Max}}{{σ}_{v beam} \sqrt{2 π}} g ( v ; {v}_{0} + δ v , {σ}_{v beam} ) \qquad ( S72 )$$

$${\vert y \vert}^{2} ( v ) = \frac{{I}_{b}^{Max}}{{σ}_{v beam} \sqrt{2 π}} g ( v ; {v}_{0} , {σ}_{v beam} ) \qquad ( S73 )$$

$$P ( t ) = Q ( t ) = G ( t ; 0 , \sqrt{2} {σ}_{t pulse} ) \qquad ( S74 )$$

$${I}_{a} ( t ) = {{I}_{a}^{Max} ( P ( t ) )}^{2} = {I}_{a}^{Max} G ( t ; 0 , {σ}_{t pulse} )$$

$${I}_{b} ( t ) = {{I}_{b}^{Max} ( Q ( t ) )}^{2} = {I}_{b}^{Max} G ( t ; 0 , {σ}_{t pulse} )$$

where it is assumed that the two parent beam lineshapes have the same Gaussian frequency standard deviation oy beam and the two pulses have the same time standard deviation σ_{t pulse}; and allows for a small difference in central frequency δv between the parent beams but have the two pulses perfectly synchronized. Note that the convention is chosen that σ_{t pulse} describes the Gaussian width of the pulse in the intensity I(t), and so the Gaussian widths of the amplitude modulations P(t) and Q(t) are greater by a factor of \sqrt{2}.

There is first evaluated the classical term from Eq. S71:

$$( S75 )$$

$$\begin{matrix}\frac{1}{4} ( ( {I}_{a} + {I}_{b} ) ⋆ ( {I}_{a} + {I}_{b} ) ) ( Δ t ) = \frac{1}{4} ( {( {I}_{a}^{Max} + {I}_{b}^{Max} )}^{2} ( G ( t ; 0 , {σ}_{t pulse} ) ⋆ G ( t ; 0 , {σ}_{t pulse} ) ) ( Δ t ) ) \\ = \frac{1}{4} {( {I}_{a}^{Max} + {I}_{b}^{Max} )}^{2} \sqrt{π} {σ}_{t pulse} G ( Δt ; 0 , \sqrt{2} {σ}_{t pulse} ) .\end{matrix}$$

The interference term is also quite straightforward for the simple case; first for the pulse shape factor:

| [symbol] [PQ]|²=|F[G(t;0,σ_{t pulse})]|²=|σ_{t pulse}\sqrt{2π}g(v;0,1/2πσ_{t pulse})|²=\sqrt{2π}σ_{t pulse}_{²}g(v;0,1/2\sqrt{2}πσ_{t pulse})

And for the parent CW beam width factor:

$$\begin{matrix}{\vert x ( v ) \vert}^{2} ⋆ {\vert y ( v ) \vert}^{2} = \frac{{I}_{a}^{Max} {I}_{b}^{Max}}{{σ}_{v beam}^{2} 2 π} ( g ( v ; {v}_{0} + δ v , {σ}_{v beam} ) ⋆ g ( v ; {v}_{0} , {σ}_{v beam} ) ) ( v ) \\ = \frac{{I}_{a}^{Max} {I}_{b}^{Max}}{{σ}_{v beam}^{2} 2 π} \sqrt{π} {σ}_{v beam} g ( v ; δ v , \sqrt{2} {σ}_{v beam} )\end{matrix} \qquad ( S76 )$$

Substituting into Equation S71, carrying out the final cross-correlation, inverse Fourier transform, and taking the real part arrives at the full interference term:

$$- \frac{1}{2} Re \{ {\text{?}}^{- 1} [ ( ( {\vert x \vert}^{2} ⋆ {\vert y \vert}^{2} ) ⋆ {\vert \text{?} [ PQ ] \vert}^{2} ) ] \} = - \frac{{I}_{a}^{Max} {I}_{b}^{Max}}{2} \sqrt{π} {σ}_{t pulse} G ( Δ t ; 0 , \frac{\sqrt{2} {σ}_{t pulse}}{{\sqrt{1 + ( 4 π {σ}_{v beam} {σ}_{t pulse}} )}^{2}} ) cos ( 2 π δ v Δ t ) \qquad ( S77 )$$

Adding the two terms from Eq. S75 and Eq. S77, and after some simplification, the pairs rate in the case of Gaussian beams and pulses can be written as:

$$( S78 )$$

$$\frac{{dN}^{( 2 )}}{d Δ t} ∝ G ( Δ t ; 0 , \sqrt{2} {σ}_{t pulse} ) - \text{?} G ( Δ t ; 0 , \frac{\sqrt{2} {σ}_{t pulse}}{{\sqrt{1 + ( 4 π {σ}_{v beam} {σ}_{t pulse}} )}^{2}} ) cos ( 2 π δ v Δ t )$$

with

$$𝒱 ≡ \frac{2 {I}_{a}^{Max} {I}_{b}^{Max}}{{( {I}_{a}^{Max} + {I}_{b}^{Max} )}^{2}}$$

The visibility [symbol] is defined from the relative intensities exactly as in Equation S64, and reaches a maximum value of 0.5 when the beam peak intensities are equal.

Equation S78 is now a complete form for the pairs rate in the case of single, synchronized Gaussian pulses, with only four shape parameters: pulse width, parent beam lineshape width, parent beam frequency offset, and HOM visibility at Δt=0. Quick checks can be made on its behavior in the two natural limits, being very wide pulses and very narrow pulses.

In the limit that σ_{t pulse} is large the first Gaussian of Eq. S78 approaches a constant with value 1 in the neighborhood around Δt=0. At the same time the standard deviation of the second Gaussian will approach σ=1/\sqrt{2}2πσ_{v beam}; and so Eq. S78 will reduce to exactly the CW case result of Equation S64 as would be expected.

In the limit that σ_{t pulse} is small, specifically small compared to 1/2πσ_{v beam}, the sigma of the second Gaussian will approach σ=\sqrt{2} σ_{t pulse}, i.e. the same as that of the first Gaussian. Factoring out the common Gaussian arrive at:

$$\frac{{dN}^{( 2 )}}{d Δ t} ∝ ( 1 - 𝒱cos ( 2 π δ v Δ t ) ) G ( Δ t ; 0 , \sqrt{2} {σ}_{t pulse} ) \qquad ( S79 )$$

Thus in the limit of short pulses, i.e. much shorter than the parent beams' coherence time, there is had the extremely simple result that the HOM interference has the effect of reducing the height of the peak in the pairs distribution at Δt=0 by a factor of (1−V), but leaving its shape the same, if the frequency mismatch δv is small enough that the cosine factor is constant.

Extension to a regular train of separated, synchronous, symmetric pulses.

In the experiment not just a single pulse is created at each input but a pulse train. The above analysis can be extended to a pulse train input beams, provided the criterion that the pulses are well-separated is satisfied. Two assumptions are made: 1) Each pulse is over by the time the next one starts, e.g. at any given time only one pulse in the train can have non-negligible intensity; 2) The interval ΔT between pulses is long compared to the widths of the pulses themselves.

Qualitatively speaking, in the case that the pulses in the train are well-separated, as above, and the arrival of a pulse in one input channel at the beam splitter is always synchronized with a pulse in the other channel, then the experiment can be thought of as a repetition at intervals of the single-pulse version. The analysis of the “central” peak around Δt=0 in the pairs distribution remains exactly as in the single-pulse case. The only change in the pairs distribution is the appearance of pairs with larger At's, away from Δt=0, which correspond to the arrival of photons pairs from non-synchronous pulses. In this case of well-separated pulses the “off-beat” pairs will not show any detectable effect of quantum interference: only the central pairs peak shows an effect, and that is identical to that in the single-pulse case.

With this in hand, the result for a regular train of synchronized Gaussian pulses at the input channels can be written. All that is needed is to copy over Equation S78 and repeat the classical term at intervals with spacing ΔT:

$$\frac{{dN}^{( 2 )}}{d Δ t} ∝ [ {\sum }_{n} G ( Δ t ; n Δ T , \sqrt{2} {σ}_{t pulse} ) ] - 𝒱 G ( Δ t ; 0 , \frac{\sqrt{2} {σ}_{t pulse}}{{\sqrt{1 + ( 4 π {σ}_{v beam} {σ}_{t pulse}} )}^{2}} ) cos ( 2 π δ v Δ t ) . \qquad ( S80 )$$

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated but fall within the scope of the appended claims.

What is claimed is:

1. A system for performing operations of quantum network, comprising:
quantum manipulating elements configured to directly manipulate and transport quantum information;
a central controller configured to synchronize and orchestrate operations of the quantum manipulating elements toward orchestrated actions, the orchestrated actions including at least generating entangled photons, quantum memory operations, and quantum measurements; and
controllable instruments configured to interface with and drive the quantum manipulating elements, the controllable instruments translating control commands from the central controller to operational parameters of the quantum manipulating elements, the controllable instruments further configured to provide feedback from the quantum measurements to the central controller.

2. The system of claim 1, wherein the controllable instruments are grouped into subsystems and setups by functionality, and further include a clocking interface used to distribute timing information to the subsystems and the setups.

3. The system of claim 2, wherein the clocking interface further facilitates sub-synchronization resolution for coherent manipulation of quantum information.

4. The system of claim 1, wherein the controllable instruments are further configured to perform compensation between distance connections to preserve coherence between disparate nodes over relevant time scales.

5. The system of claim 1, wherein the controllable instruments include at least signal generators, time-taggers, and oscilloscopes.

6. The system of claim 1, wherein the quantum manipulating elements include at least atoms, optical fibers, optical elements, and photodetectors.

7. The system of claim 1, wherein the central controller is further configured to manage the quantum information, use models that learn from data acquired from the quantum measurements to understand the quantum network, use the learned understanding for verification of the quantum network.

8. The system of claim 1, further including a first set of application programming interfaces used to interface the central controller with the controllable instruments, wherein the control commands from the central controller are communicated using one or more of the first set of application programming interfaces.

9. The system of claim 8, wherein the first set of application programming interfaces are operated independently of make and model of the controllable instruments.

10. The system of claim 1, further including a second set of application programming interfaces, used to interface the central controller with one or more user-defined quantum network applications.

11. The system of claim 10, wherein the user-defined quantum network applications include at least distributed quantum gate operations, teleportation-based services, and HOM indistinguishability verification, and entanglement swapping.

12. A method of operating quantum network, comprising:
configuring quantum manipulating elements to directly manipulate and transport quantum information;
configuring a central controller to synchronize and orchestrate operations of the quantum manipulating elements toward orchestrated actions, the orchestrated actions including at least generating entangled photons, quantum memory operations, and quantum measurements; and
configuring controllable instruments to interface with and drive the quantum manipulating elements, the controllable instruments translating control commands from the central controller to operational parameters of the quantum manipulating elements, the controllable instruments further configured to provide feedback from the quantum measurements to the central controller,
wherein the quantum network is operated via a hierarchy of interfacing the quantum manipulating elements with the controllable instruments, and interfacing the controllable instruments with the central controller.

13. A method of quantum frequency conversion, the method comprising:
receiving a first signal encoding a qubit, wherein the first signal has a first frequency;
receiving at least one laser beam;
configuring the at least one laser beam to generate at least one control beam;
merging the first signal with the at least one control beam to generate a second signal that encodes the qubit, wherein the second signal has a second frequency; and
storing the second signal in a quantum memory device.

14. The method of claim 13, wherein:
the at least one laser beam comprises a first laser beam having a third frequency and a second laser beam having a fourth frequency;
configuring the at least one laser beam comprises configuring the first beam to generate a first control beam and configuring the second beam to generate a second control beam; and
merging the first signal with the at least one control beam comprises merging the first signal with the first control beam and the second control beam to generate the second signal.

15. The method of claim 14, wherein:
the first frequency is 780 nanometers (nm);
the second frequency is 1324 nm;
the third frequency is 795 nm; and
the fourth frequency is 1367 nm.

16. The method of claim 14, wherein:
configuring the first beam to generate the first control beam comprises modulating the first beam; and
configuring the second beam to generate the second control beam comprises frequency locking the second beam.

17. The method of claim 13, further comprising attenuating the first signal comprises using an electro-optic modulator (EOM) to create a field envelope of the first signal.

18. The method of claim 17, wherein frequency locking the second beam comprises:
operating an Indium gallium arsenide (InGaAs) balanced amplified photodetector to obtain an Optical-Optical Double Resonance (OODR) spectrum;
scanning the second beam while keeping the first signal frequency locked;
generating an error signal by modulating the second beam at a predefined frequency; and
operating a proportional-integral-derivative (PID) controller to lock the second beam according to the error signal.

19. The method of claim 13, wherein merging the first signal with the at least one control beam comprises:
resonantly coupling a first state of a diamond energy scheme to a third excited state of the diamond energy scheme, wherein the diamond energy scheme comprises:
the first state that is a ground state;
a second state that is an excited state having higher energy than the first state;
a third state higher that is an excited state having higher energy than the second state;
a fourth state that is an excited state having higher energy than the third state, wherein an input quantum field that receives the first signal is connected by the first state and the third state of the diamond energy scheme and an output quantum field that outputs the second signal is connected by the second state and the fourth state of the diamond energy scheme;
coupling the first state to the second state; and
coupling the third state to the fourth state of the diamond energy scheme.

20. The method of claim 13, further comprising filtering out the at least one control beam to obtain the second signal.

21. The method of claim 20, wherein filtering out the at least one control beam comprises using a Glan laser (GL) polarizer and at least one wavelength filter.

22. The method of claim 13, wherein the quantum memory device is a room temperature vapor cell.

23. A system comprising:
a combination optics apparatus configured to:
generate a first signal encoding a qubit, wherein the first signal has a first frequency;
generate at least one laser beam;
generate at least one control beam based on the at least one laser beam to;
a frequency conversion apparatus configured to:
merge the first signal with the at least one control beam to generate a second signal that encodes the qubit, wherein the second signal has a second frequency; and
store the second signal in a quantum memory device.

24. The system of claim 23, wherein the combination optics apparatus comprises:
a first laser pump field configured to generate the first signal; and
at least one additional laser pump field configured to generate the at least one laser beam.

25. The system of claim 24, wherein:
the at least one laser beam comprises a first laser beam having a third frequency and a second laser beam having a fourth frequency;
the at least one additional laser pump field comprises:
a second laser pump field configured to generate the first laser beam; and
a third laser pump field configured to generate the second laser beam.

26. The system of claim 25, wherein:
the combination optics apparatus is configured to:
configure the first beam to generate a first control beam;
configure the second beam to generate a second control beam; and
the frequency conversion apparatus is configured to merge the first signal with the first control beam and the second control beam to generate the second signal.

27. The system of claim 25, wherein:
the first frequency is 780 nanometers (nm);
the second frequency is 1324 nm;
the third frequency is 795 nm; and
the fourth frequency is 1367 nm.

28. The system of claim 25, wherein the combination optics apparatus is configured to:
configure the first beam to generate the first control beam by modulating the first beam; and
configure the second beam to generate the second control beam by frequency locking the second beam.

29. The system of claim 23, wherein the combination optics apparatus is configured to attenuate the first signal using an electro-optic modulator (EOM) to create a field envelope of the first signal.

30. The system of claim 28, to frequency lock the second beam, the combination optics apparatus is configured to:
operate an Indium gallium arsenide (InGaAs) balanced amplified photodetector to obtain an Optical-Optical Double Resonance (OODR) spectrum;
scan the second beam while keeping the first signal frequency locked;
generate an error signal by modulating the second beam at a predefined frequency; and
operate a proportional-integral-derivative (PID) controller to lock the second beam according to the error signal.

31. The system of claim 23, wherein to merge the first signal with the at least one control beam, the frequency conversion apparatus is configured to:
resonantly couple a first state of a diamond energy scheme to a third excited state of the diamond energy scheme, wherein the diamond energy scheme comprises:
the first state that is a ground state;
a second state that is an excited state having higher energy than the first state;
a third state higher that is an excited state having higher energy than the second state;
a fourth state that is an excited state having higher energy than the third state, wherein an input quantum field that receives the first signal is connected by the first state and the third state of the diamond energy scheme and an output quantum field that outputs the second signal is connected by the second state and the fourth state of the diamond energy scheme;
couple the first state to the second state; and
couple the third state to the fourth state of the diamond energy scheme.

32. The system of claim 23, wherein the frequency conversion apparatus is configured to filter out the at least one control beam to obtain the second signal.

33. The system of claim 32, wherein the frequency conversion apparatus comprises a Glan laser (GL) polarizer and at least one wavelength filter configured to filter out the at least one control beam.

34. The system of claim 23, wherein the quantum memory device is a room temperature vapor cell.

35. A method for determining a degree of indistinguishability among qubits, the method comprising:
receiving a first packet of photons from a first quantum memory;
receiving a second packet of photons from a second quantum memory;
determining a first arrival time of the first packet of photons;
determining a second arrival time of the second packet of photons;
determining a difference between the first arrival time and the second arrival time;
determining a coincidence rate between the first packet of photons and the second packet of photons; and
determining a Hong-Ou-Mandel (HOM) visibility based on the coincidence rate and a difference between the first arrival time and the second arrival time, wherein the HOM visibility indicates the degree of indistinguishability between the first packet of photons and the second packet of photons.

36. The method of claim 35, wherein:
the first packet of photons are received from the first quantum memory via a first optical path having a first distance; and
the second packet of photons are received from the second quantum memory via a second optical path having a second distance different from the first distance.

37. The method of claim 35, further comprising:
compensating a polarization of the first packet of photons; and
compensating a polarization of the second packet of photons.

38. The method of claim 35, wherein a difference between a mean number of photons in the first packet of photons and a mean number of photons in the second packet of photons is within a predefined threshold that maximizes the HOM visibility.

39. The method of claim 38, wherein the mean number of photons in the first packet of photons and the mean number of photons in the second packet of photons are defined within one pulse temporal envelope.

40. The method of claim 35, wherein:
the first packet of photons and the second packet of photons are received by a HOM detection system; and
the HOM detection system, the first quantum memory and the second quantum memory are located in the same location.

41. The method of claim 40, wherein the same location including the first quantum memory, the second quantum memory and the HOM detection system is a first location, and the method further comprising:
receiving, by the first quantum memory, the first packet of photons from a first light source located in a second location different from the first location; and
receiving, by the second quantum memory, the second packet of photons from a second light source located in a third location different from the first location and different from the second location.

42. The method of claim 35, further comprising:
compensating a polarization of the first packet of photons and a polarization of the second packet of photons using a plurality of optical components to direct macroscopic light to polarimeters for measurement; and
automatically removing the plurality of optical components to release the first packet of photons and the second packet of photons to a HOM detection system.

43. The method of claim 35, wherein determining the coincidence rate comprises:
determining the first arrival time is within a period of time;
determining the second arrival time is within the period of time; and
in response to determining the first and second arrival times are within the period of time, recording a count of coincidence.

44. The method of claim 43, wherein:
the first arrival time is a photon detection event among a first set of photon detection events in a first channel that receives the first packet of photons;
the second arrival time is a photon detection event among a second set of photon detection events in a second channel that receives the second packet of photons; and
the count of coincidence is among a number of counts of coincidence.

45. The method of claim 44, wherein the number of counts of coincidence is a first number of counts of coincidence:
adding a delay to at least one of the first channel and the second channel;
monitoring, with the added delay, the first set of photon detection events in the first channel and the second set of photon detection events in the second channel;
determining a second number of counts of coincidence from the monitoring with the added delay; and
determining a relationship between the first number of counts of coincidence and the second number of counts of coincidence.

46. The method of claim 45, further comprising adjusting, based on the relationship between the first number of counts of coincidence and the second number of counts of coincidence, the delay to minimize the coincidence rate, where minimizing the coincidence rate maximizes the HOM visibility and the degree of indistinguishability.
